(19) United States
(12) Patent Application Publication
(10) Pub. No.: US 2003/0014441 A1
(43) Pub. Date: Jan. 16, 2003

(54) Document data structure, information recording medium, information processing apparatus, information processing system and information processing method

(76) Inventors: Akira Suzuki, Kanagawa (JP); Masami Koide, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/183,613

(22) Filed: Jun. 28, 2002

(30) Foreign Application Priority Data
Jun. 29, 2001 (JP) 2001-198818
Sep. 20, 2001 (JP) 2001-287273
Sep. 20, 2001 (JP) 2001-287275
Sep. 21, 2001 (JP) 2001-288515
Sep. 21, 2001 (JP) 2001-289781
Sep. 21, 2001 (JP) 2001-290175

(51) Int. Cl. G06F 15/00

(52) U.S. Cl. 707/513

(57) ABSTRACT

An encapsulated document includes digital information files of substance of document, a display information file for indicating a display state of the digital information files on the document, an operation program file read and executed by a computer for displaying the information files according to the display state indicated by the display information file. The digital information files and operation program files are encapsulated into one document.

### BACKGROUND OF THE INVENTION

1. Field of the Invention

The present invention relates to a document data structure which can be viewed and managed by a computer (digital information processing apparatus), an information recording medium storing therein the data structure, the information processing apparatus, information processing system and method concerning the document data structure.

2. Description of the Related Art

In recent years, documents in various forms are created and spread as a communication medium which can be viewed by using a computer (digital information processing apparatus). As typical forms of such documents, there are a text, a rich text, multimedia, PDF, HTML, MHTML, XML, etc., for example. Then, the documents in such forms of various types will now be briefly described based on development history thereof.

[Text, Rich Text, Multimedia]

As typical ones of digital documents which can be handled by a computer or digital information processing apparatus, there are a so-canned ‘text’ document in which a text is expressed by a character code; a ‘rich text’ document in which a plurality of types of character fonts can be used in the above-mentioned text document, and a ‘multimedia’ document in which, further, it is possible to insert a figure, an image, an animation, a sound, etc., there.

Usually, the text document uses a character code common to general-purpose computers. Accordingly, a general-purpose computer has a text editor attached to an operation system thereof by which viewing and editing of the text document can be made.

Moreover, in transmitting and receiving information by E-mail (Electronic mail), text information can be transmitted, and, thereby, information can be exchanged. Also, recently, an E-mail software which can transmit and receive a document expressed in rich text is also general.

On the other hand, although no general format exists for a multimedia document, since the ‘Office’ (brand name) containing the ‘Word’ (brand name) of Microsoft Corp. etc. has now spread widely, the present condition is that this Office format may be treated as a standard format.

However, when the Office format is used for a multimedia document, viewing the multimedia document also needs to purchase application software of the Office of Microsoft Corp. which includes a document producing function, and thus, the user needs to install it in his or her own computer-.

[PDF]

A format called ‘PDF’ which Adobe developed is known as a document format corresponding to a multimedia document. Although an application of this format for producing a document is not free, an application for viewing the document is free for distribution.

However, when a user wishes to view a PDF document, the user still needs to install a browser of Adobe.

[HTML]

It is common to describe information in a language called HTML (Hyper Text Markup Language) with proliferation of the Internet.

The HTML document began to spread widely as a language used by application software called ‘navigator’ the Netscape company developed, and contributed to the rapid spread of the Internet at the beginning.

Then, Microsoft Corp. included software called Internet Explorer which uses the HTML language in Windows which is an operation system as a standard. Accordingly, it is not necessary for a user to separately install the browser software for viewing the HTML document. Now, the Internet Explorer has spread explosively, and it is treated as if it was a standard format of Internet browser.

However, such a HTML document has a problem relating to its history of birth, as a format for producing an ordinary document. As a technique of viewing a document according to the Internet, a user's computer displays a document visually according to a predetermined tag rule of HTML when the information described by HTML is of simply a text document. However, when information relates to an image, the information itself does not actually include image information currently displayed as the HTML information. That is, when the information relates to image, the HTML information merely includes information indicating a place at which the image information itself is located, and software for viewing installed in the user's computer downloads the image information from a predetermined server to the user's computer based on this location information. As a result, the relevant image is first displayed there.

Accordingly, a content provider should always place a relevant image file at a predetermined place so that a user can actually view image information through downloading it therefrom at any times. For this purpose, the content provider should always manage such a type of image information.

[MHTML]

In order to solve this problem, an RFC which is an Internet standard organization has studied for a format called an MHTML form in which such multimedia contents can be held together with HTML information. According to the MHTML form, a multimedia document containing an image etc. can be viewed by a view software corresponding to this standard.

However, since the MHTML is a format created from extending the HTML, it has some problems.

One of them is caused from a fact that image data or the like is not held as binary data but as character code expressed by hexadecimal notation (from 0 through 9, and A through F). This originates in a fact that an HTML file described by HTML is produced in a manner such that the contents of description can be viewed by a predetermined text editor.

As another problem, since an image etc. is held in a same file in which also arrangement information for arranging the image, etc. is held, the MHTML document has a problem that it is not possible to simply extract the image only, or to simply refer only to the contents of description, individually.

Thereby, at the present situation, in many cases, Word documents are used in personal computers locally, while HTML documents are used on the Internet.

[XML]

Recent years, for the purpose of solving this problem, XML (Extensible Markup Language) has been proposed, as a document format for connecting local documents and Interne documents.

According to XML, a user himself of herself can define a tag equivalent to a tag of HTML. Thereby, it is possible to create a document by which, by means of tag, binary data described in unique formats by various types of software can be visually managed through a predetermined text editor. However, an XML document merely defines how to describe data, and, therefore, in order to realize actual operation thereon, a program for reading and executing/operating the XML document, a predetermined program execution environment, and also, a computer (digital information processing apparatus) are needed as necessary conditions. Then, when a different program is used for displaying the same XML document, different display contents may result. Similarly, different types of computers or different types of program execution environments may display the same XML document in different manners.

In fact, even when it is possible to unify a data format, it may not be possible to unify a program or a type of computer to execute it. Accordingly, it is difficult to provide a condition in which a same XML document can be viewed in a same manner for any users.

[Program Environment of Multi-Platform]

Then, a multi-platform program environment has been proposed which does not depend on a type of computer (digital information processing apparatus), in other words, does not depend on a type of operation system. Typically, there are JAVA of Sum Micro Systems company, and NET design of Microsoft Corp. Thus, for example, by describing a document by XML format, or by describing by a multi-platform language such as JAVA, it should be possible to view the document in a same manner without depending on type of computer or type of operation system applied.

A combination between XML format and JAVA is disclosed by Japanese laid-open patent application No. 2000-353120. According thereto, an XML document is read, and, then, based thereon, a program described by JAVA is executed.

Japanese laid-open patent application No. 134349 discloses data description according to XML, format and a document prescribing operation of program thereby.

According to these disclosures, a program is started based on a description of XML etc., and multimedia contents or documents are thus displayed. That is, data is described by XML etc. for a combination of data and an application to process the data. Thereby, it is possible to describe a document in a general manner, and, also, to view such a document in a unified manner by processing document data by means of an application program such as those by means of JAVA or the like.

### SUMMARY OF THE INVENTION

However, it may be troublesome for a user to install such an application program for processing so as to display document data. Furthermore, when the version of such an application program is updated, the proper operation may not necessarily be performed. Therefore, in case where a some document should be held for a long term, an application program for processing and displaying it should also be held together. Thus, troublesomeness may occur.

Further, when an application program for processing a document is held together with the document itself, two files should be stored for one document. In this relation, Japanese laid-open patent application No. 11-143906 discloses to hold a plurality of WEB-page files in a form of a book. However, even in this case, even when they are held in a form of a single book, the plurality of files are actually stored, and, thus, this system is different from a system in which information necessary for holding a single document is managed as a single file.

In order to produce, edit, store, and view an electronic document, the following conditions are required:

(1) a hardware (computer) actually performing data processing;

(2) an operation system (OS) causing the computer to perform the processing;

(3) a software program (application software) for reading the document information and performing display, editing, etc.;

(4) document information expressing the document contents by a predetermined digital description.

That is, the electronic document cannot be viewed properly unless these four conditions are satisfied. The operation system, such as Windows, is installed in the computer., and the computer and operation system can be said to correspond to one another. Then, a typical application program which suits the computer and operation system is installed in the computer, and, thereby, a user can perform creation, viewing etc. on the document.

Therefore, an important matter for enabling proper viewing of the document information is whether or not the application program installed is suitable. That is, when a document is viewed, unless an application program which a user uses for viewing the document data has a compatibility with an application program which a creator of the same document, it is not possible for the user to properly view the document data. Even when both the application programs are same as one another, it may not be possible to properly view the document if the versions thereof are different. Such a problem may cause troublesomeness on the user.

There are various document forms for electronic documents, i.e., text, rich text, PDF, HTML, MHTML, XML and so forth, as mentioned above. However, roughly speaking, document forms for electronic documents may be classified into two categories, i.e., the Office document of Microsoft Corp., and the WEB document viewed by a WEB browser. However, for the Office document of Microsoft Corp., there is a problem that the Office application is needed for viewing the document data. Moreover, since a WEB document is a document specialized for the Internet, a single document may include a plurality of files because the WEB document calls/downloads so as to enable viewing of the plurality of files held by a remote server. Thus, as mentioned above, management work for managing such a plurality of files for a single WEB document may be troublesome on a manager of the server.

Furthermore, recently, a digital document comes to be able to include not only conventional character expression (text) but also a still image, an animation image, and/or a sound data, with a recent rapid improvement in computer technology, and the throughput of personal computer. Then, by means of a personal computer, a document form covering a plurality of media and thus including conventional character/text document form cultivated by conventional printing-type documents and recent image data form cultivated on a radio and television broadcast communication can be produced and viewed. Such a type of document form is distributed/dispatched through a global communication network such as the Internet. Generally, such a digital document is called ‘multimedia document’.

As a multimedia document may cover a plurality of media, a plurality of types of application programs are needed for viewing the document. In order to view a multimedia document:

(1) an application program is required for viewing;

(2) a common producing and viewing environment is required between a document creator and a user;

(3) a plurality of files may be used for producing a single document; and

(4) in order to view a past document currently held, an application program for viewing it should be also held together.

Therefore, there may be a difficulty for a general user to treat a multimedia document.

A purpose of the present invention is to enable viewing a desired digital information file, without installing a specific operation program file in a computer beforehand so as to prepare an environment.

Another purpose of the present invention is enabling treatment of a plurality of digital information files as a single document even when these files have different document forms, so as to attain easy document management/treatment.

In order to achieve the objects, a document data structure according to the present invention includes at least one digital information file, an operation program file for displaying the at least one digital information file, and an encapsulating part encapsulating these files into one document. Thereby, the digital information files can be viewed as a result of the operation program file being executed by a computer. Therefore, a user becomes free from installing the necessary operation program file solely beforehand. In fact, before the digital information file is actually obtained, the user may not precisely estimate which types of digital information files including the above-mentioned digital information file will be obtained actually. Accordingly, if the encapsulated document according to the present invention were not provided, the user should install operation program files of various types beforehand which may be needed in future.

Furthermore, as the digital information file and corresponding operation program file are encapsulated into a single document, it is easy even for a general user to handle them.

It is preferable that the encapsulated document has a communication function. Thereby, for example, in a remote meeting by means of computer communication network, communication between members of the meeting can be efficiently achieved by utilizing the document as a communication medium.

Further, it is also preferable that the document has a summary display function. Thereby, for example, in occasion of demonstration/presentation of some plan in use of the document as communication medium, a superior effect can be obtained.

Furthermore, it is also preferable that the document has a function of recording a user's operation performed on the document. Thereby, for example, page turning over operations may be checked afterward.

Furthermore, it is also preferable that the document has a function of obtaining the necessary operation program file from another computer via a communication network. Thereby, it is possible to slim down the data size of the net document.

Furthermore, it is also possible to provide a system by which production of the above-mentioned encapsulated document is performed by procuration by a server system or the like. Thereby, a document creator becomes free from troublesome of document encapsulation work.

Other objects and further features of the present invention will become more apparent from the following detailed description when read in conjunction with the accompanying drawings.

### BRIEF DESCRIPTION OF THE DRAWINGS

FIG. 1 shows a typical configuration of an encapsulated document according to one embodiment of the present invention;

FIG. 2 shows a typical data structure of a library file applicable to the embodiment of the present invention;

FIG. 3 shows another typical data structure of a library file also applicable to the embodiment of the present invention;

FIG. 4 shows a typical data structure of a program shown in FIG. 1;

FIG. 5 shows a typical data structure of an expansion program reference file included in the program shown in FIG. 1;

FIG. 6 shows a typical example of an encapsulated document according to the embodiment of the present invention;

FIG. 7 shows a typical example of a display image of an encapsulated document according to the embodiment of the present invention described by XML;

FIG. 8 shows a hardware configuration of a personal computer to which the embodiment of the present invention may be applied;

FIG. 9 shows a flow chart which shows an operation flow of a document display processing with the personal computer according to the embodiment of the present invention;

FIG. 10 shows an operation flow of document display processing of an encapsulated document in the embodiment of the present invention performed with the personal computer;

FIG. 11 shows a file structure of a file specifying a correspondence relation between various types of media and expansion programs according to the embodiment of the present invention;

FIG. 12 shows types of expansion program according to the embodiment of the present invention;

FIG. 13 shows an example of a display image having a page turning-over button according to the embodiment of the present invention;

FIG. 14 shows an example of description of a function operation program file according to the embodiment of the present invention;

FIG. 15 shows a processing of using an auxiliary program for encoding a given file according to the embodiment of the present invention;

FIG. 16 illustrates a magnification/reduction function of a display image by means of an expansion program according to the embodiment of the present invention;

FIG. 17 illustrates a viewpoint change function of a display image in solid image by means of an expansion program according to the embodiment of the present invention;

FIG. 18 illustrates a still image display function and animation reproduction function for an animation image according to the embodiment of the present invention;

FIG. 19 illustrates a voice reproduction function and a function of converting the reproduction sound into text information by expansion programs according to the embodiment of the present invention;

FIG. 20 illustrates a structure of the expansion programs included in the encapsulated document according to the embodiment of the present invention;

FIG. 21 illustrates an example of a displayed document which shows three digital information files (PRG1, PRG2, PRG3) according to the embodiment of the present invention;

FIG. 22 shows an operation flow of establishment processing for communications between encapsulated documents according to the embodiment of the present invention;

FIG. 23 illustrates a document identification code according to the embodiment of the present invention;

FIG. 24 shows an operation flow of establishment processing for communications among a plurality of encapsulated documents according to the embodiment of the present invention;

FIG. 25 shows an operation flow of processing of a list server according to the embodiment of the present invention;

FIG. 26 shows an operation flow of processing of disconnecting communications between the encapsulated documents according to the embodiment of the present invention;

FIG. 27 shows an example of a synchronization button displayed on a document panel of encapsulated document according to the embodiment of the present invention;

FIG. 28 shows an operation flow of processing performed after the synchronization button is clicked according to the embodiment of the present invention;

FIG. 29 shows more pluralistically the processing shown in the flow chart of FIG. 28;

FIG. 30 shows a state where two encapsulated documents A and B are synchronized according to the embodiment of the present invention;

FIG. 31 shows an operation flow of another synchronization processing according to the embodiment of the present invention;

FIG. 32 shows an operation flow of processing for list server's transference according to the embodiment of the present invention;

FIG. 33 shows an example of a display of encapsulated document described by XML as shown in FIG. 6 according to the embodiment of the present invention;

FIG. 34 shows an example of document arrangement information for arranging summary information according to the embodiment of the present invention;

FIG. 35 shows an operation flow of processing of expansion program for summary display according to the embodiment of the present invention;

FIG. 36 shows an example of summary display displayed in a summary frame in a view document on a display device according to the embodiment of the present invention;

FIGS. 37A, 37B and 37C illustrate a display manner according to an emphasis display scheme of summary display according to the embodiment of the present invention;

FIG. 38 illustrates a procedure of collecting document states of the document currently displayed according to the embodiment of the present invention;

FIG. 39 illustrates a data structure of record data which a recording program records according to the embodiment of the present invention;

FIG. 40 shows an example of a display image at a time of the recording according to the embodiment of the present invention;

FIG. 41 shows an operation flow of processing which an expansion program performs according to operation of a record display slider according to the embodiment of the present invention;

FIGS. 42 and 43 show operation flows of reproduction processing concerning the recording function according to the embodiment of the present invention;

FIG. 44 shows an operation flow of time setting processing according to the embodiment of the present invention;

FIG. 45 illustrates a search word input panel concerning the recording function according to the embodiment of the present invention;

FIG. 46 shows an operation flow of processing in case a required operation program file does not exist in an encapsulated document according to the embodiment of the present invention;

FIG. 47 shows an operation flow of processing for document view permission by a server which has received a program transmission request according to the embodiment of the present invention;

FIG. 48 shows an operation flow of receipt processing for a file for a meeting participant display according to the embodiment of the present invention;

FIG. 49 shows an operation flow of updating processing for digital information file or operation program file according to the embodiment of the present invention;

FIG. 50 shows an operation flow of download processing to a client of mass contents which a server holds according to the embodiment of the present invention;

FIG. 51 shows an operation flow of renewal processing of version information in a digital information file or an operation program file according to the embodiment of the present invention;

FIG. 52 shows a client/server system built using the Internet according to an embodiment of the present invention;

FIG. 53 shows an operation flow of a procedure between server and client which are connected through the Internet according to the embodiment of the present invention;

FIG. 54 shows a conversion service screen for document conversion service which the client receives from the server according to the embodiment of the present invention;

FIG. 55 illustrates a security protection technique on the communication network according to the embodiment of the present invention;

FIG. 56 illustrates a language conversion function according to the embodiment of the present invention;

FIG. 57 illustrates an annotation function according to the embodiment of the present invention;

FIG. 58 illustrates a meaning data file according to the embodiment of the present invention; and

FIG. 59 illustrates an operation flow of processing for adding a annotation to a technical term in a displayed document according to the embodiment of the present invention;

### DETAILED DESCRIPTION OF THE PREFERRED EMBODIMENTS

One embodiment of the present invention will now be described with reference to figures.

[Data Structure of Document (Encapsulated Document)]

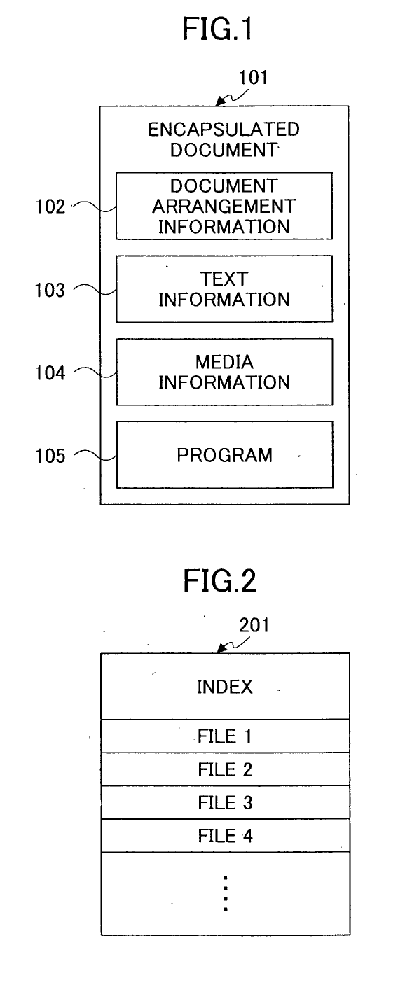

FIG. 1 shows a typical view showing a data structure of an encapsulated document according to the embodiment of the present invention.

As shown in the figure, the encapsulated document 101 includes document arrangement information 102, text information 103, media information 104, and a program 105. The arrangement information is in a form of a display information file for indicating display states, such as a structure of the whole document, arrangement of particular information pieces, and so forth. The text information 102 is in a form of a digital information file indicating the contents of the text included in the relevant document. The media information 104 is in a form of a digital information file indicating other still images, animation images, or the like. The program 105 includes a plurality operation program files used for displaying the contents of the document, detecting user's operation, and so forth. The above-mentioned various types of information have a structure of respective individual file units which an operation system of a common personal computer can manage.

The encapsulated document 101 can be stored in various types of storage media, such as an optical storage medium, such as CD, CD-ROM, CD-R, CD-RW, DVD-ROM, and DVD-RAM, a magnetic storage medium such as a floppy disk, a hard disk, and a magnetic tape, and, thus, can be carried easily in a form of storage medium. Moreover, the encapsulated document 101 can be transmitted through various types of communication circuits, such as LAN, Internet, etc.

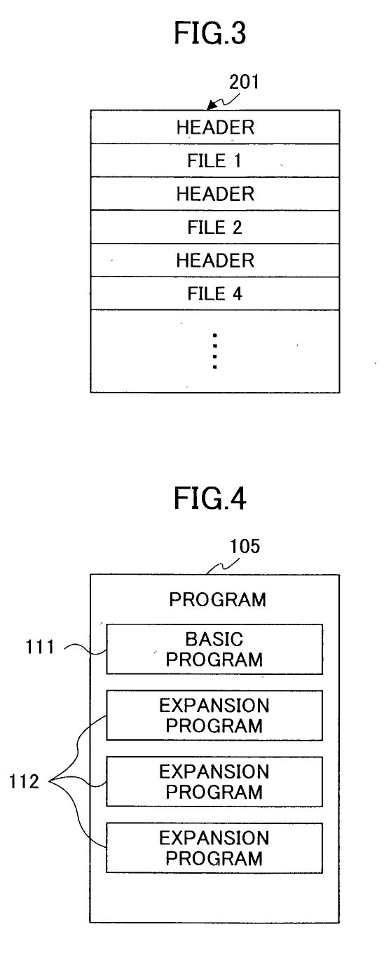

FIG. 2 illustrates a typical example of a data structure of a library file and FIG. 3 shows another data structure of the library file both of which can be applied to the embodiment of the present invention.

The above-mentioned respective files 102, 103, 104, and 105 of the encapsulated document 101 are held in one file called a library file 201, shown in FIG. 2 or 3. Thereby, the document arrangement information 102 (display information file), the text information 103 (digital information file), the media information 104 (digital information file), and the program 105 (operation program file or files) are encapsulated as a single document. As a file format of such a library file 201, generally, there are a ZIP form, an LHA form, etc. and any of such technologies may be used for this purpose.

The library file 201 has a file structure such as to hold a plurality of files 102, 103, 104, and 105 as a single file (library file 201). Such a library file 201 can be handled as a single file (library fine 201) according to a user's request by means of a so-called archiver program which has a storing function and a decompressing function.

In the example shown in FIG. 2, index information is attached to the plurality of files 102, 103, 104, 105 for indicating places the respective files are located, in the library file 201. Thereby, it is possible to determine the positions of the respective files 102, 103, 104, and 105.

In the example shown in FIG. 3, header information is attached to each of these files 102, 103, 104 and 105 for indicating the positions of the respective files. Thereby, it is possible to determine the positions of the respective files 102, 103, 104, and 105.

Thus, the file structure of the encapsulated document 101 has a library file format by which the plurality of files 102, 103, 104, and 105 are managed by means of the index information or header information. Thereby, a user can manage the plurality of files 102, 103, 104 and 105 apparently as a single file.

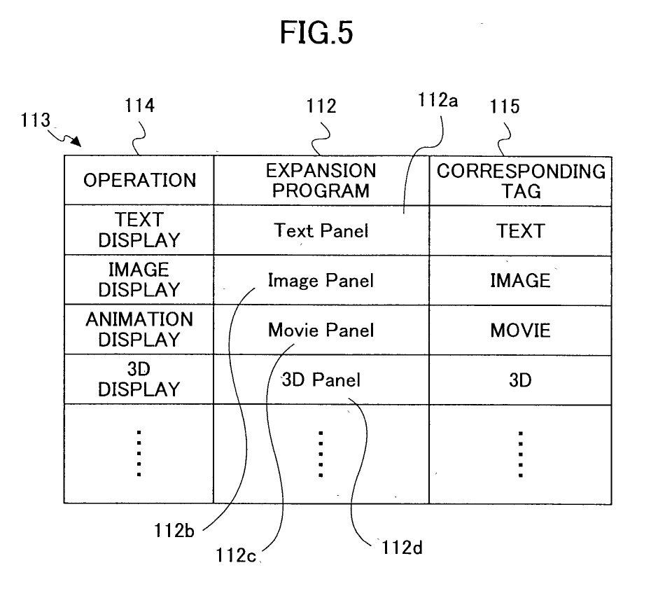

FIG. 4 illustrates a typical data structure of the program 105 held in the encapsulated document 101, and FIG. 5 illustrates a typical structure of a display information file 102 which specifies information concerning expansion programs included in the program 105.

The program 105 which include a plurality of operation program files held in the encapsulated document 101 includes a basic program 111 and expansion programs 112, as shown in FIG. 4.

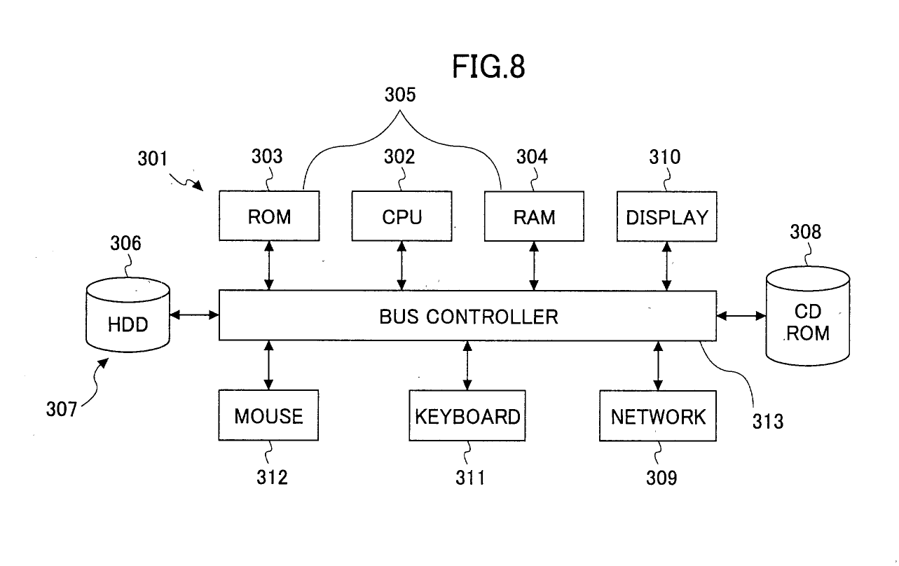

The basic program 111 is a program which can be called at a time of starting of the encapsulated document 101, and is a program which exists only one in common throughout the encapsulated documents 101. This basic program 111 includes a startup program which is not shown, responds to access of the encapsulated document 101 by a personal computer 301 (see FIG. 8), is interpreted and performed by the personal computer 301 and thus, is started up.

The expansion programs 112 are added according to the contents contained in the encapsulated document 101, and, for example, prepared according to particular types of display media, i.e., text, still (picture) images, animation (video) images, 3D display image, etc., as shown in FIG. 5. When a digital information file included in the encapsulated document 101 is only text information 103 as an example, in addition to the basic program 11, a text panel program 112a of the expansion program 112 is held in the encapsulated document 101. Moreover, when the media information 104 as digital information file showing a still image, an animation image, etc. is held in the encapsulated document 101, in addition to the basic program 111, an image panel program 112b, a movie panel program 112c, and a 3D panel program 112d of the expansion programs are held in the encapsulated document 101.

FIG. 5 shows an example of an expansion program reference file 113, and this expansion program reference file 113 specifies tags 115 and operations 114 corresponding to the respective expansion programs 112. Such an expansion program reference file 113 may be held in the encapsulated document 101 as the program 105.

Next, the document arrangement information 102 will now be described. The document arrangement information 102 is a file which describes arrangement of respective media of the encapsulated document 101, display size, files of respective media, etc. According to the embodiment of the present invention, such a type of information is described according to a general-purpose XML form.

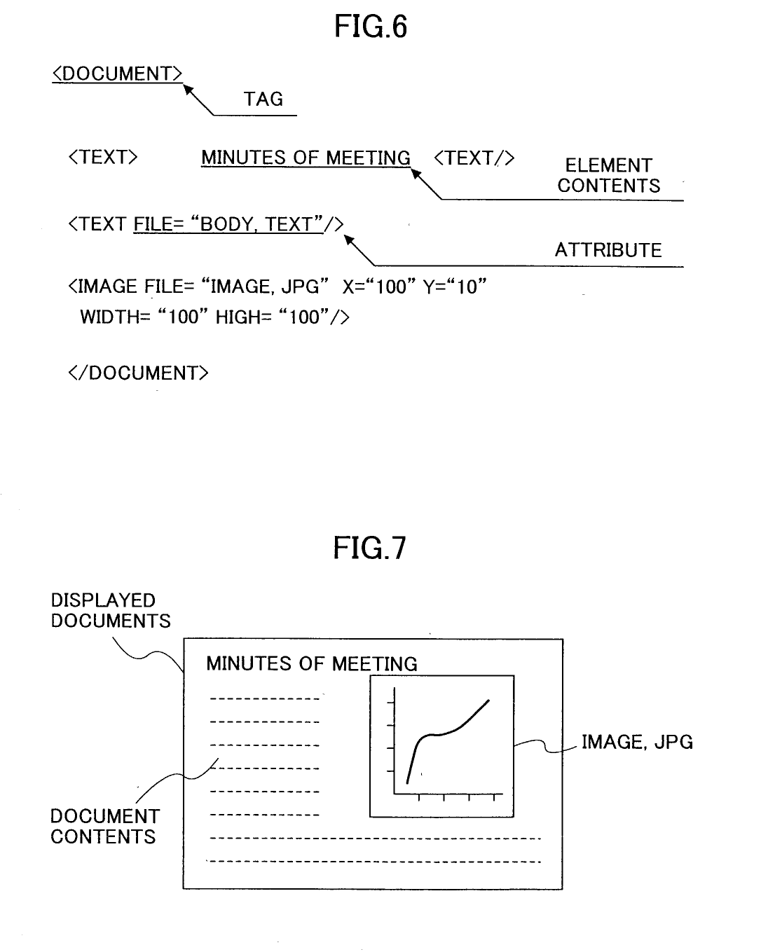

FIG. 6 illustrates a typical example of the encapsulated document 101 described by XML. XML is a file format in which each element is described by a unit called ‘tag’, and a document is described by means of collection of the tags. In this case, it is possible to take an embedded structure in which a tag inserted in a tag, and, also, it is possible to add an attribute to each tag for indicating an attribute of the tag.

FIG. 7 illustrates a typical view of an example of display contents of the encapsulated document 101 described by XML as shown in FIG. 6. The encapsulated document 101 as shown as the example of FIG. 7 is displayed based on the description of XML shown in FIG. 6.

First, as shown in FIG. 6, a tag <DOCUMENT> and </DOCUMENT> showing the whole document is described, and the structure of the document is described therebetween. Then, a title is displayed first by means of a tag <TEXT> and </TEXT> having the title described therebetween. In this case, the attribute is omitted. Then, by the following tag <TEXT FILE=“BODY, TEXT”/>, text information is read in from a file “BODY TEXT”. By the following tag <IMAGE FILE=“IMAGE, JPG” X=“100”, Y=“10”, WIDTH=“100” HEIGHT “100”/>, which acts as arrangement information, a still image “IMAGE, JPG” is displayed from the origin indicated by the x, y coordinate, by a size specified by WIDTH and HEIGHT.

Thus, the document arrangement information 102 provides instructions for a file to be read out, and instructions for arrangement of image to be displayed, according to XML form.

Although the document arrangement information 102 is described according to XML in this embodiment, another description language, such as an HTML form, may be used instead, or, another original description form may be applied instead.

As to the other media information 104 expressing still images, animation images, 3D images, voice information, etc. may be of general-purpose file formats, or, may be of original formats in case some special specification is applied. ,As described above, the file structure of the encapsulated document 101 includes the document arrangement information 102 indicating the structure of the whole document, the plurality of media files (text information 103 and media information 104) displayed according to the arrangement information 102, such as the text information file and image file, and the plurality of sets of program 105.

[Viewing/Displaying of Encapsulated Document 101]

A basic operation of the encapsulated document 101 according to the embodiment of the present invention starting from a document starting step through a document viewing step will now be described. First, for the purpose of comparison, operation of a common personal computer and a document viewing operation according to a related art will now be described.

FIG. 8 shows a hardware configuration of the common personal computer 301 (computer). The personal computer 301 includes a CPU 302, a primary storage device 305 such as ROM 303 and RAM 304, a secondary storage device 307 such as a hard disk drive 306, a removable medium 308 such as a CD-ROM, a network interface device 309, a display device 310, a keyboard 311, a mouse 312, and so forth. The CPU 302 processes various types of information, the primary storage device 305 stores the information, the secondary storage device 307 saves processing results, etc., the removable recording medium 308 is used for keeping various information externally, the network interface device 309 performs communications with an external communication network, and keyboard 311 and mouse 312 are used for a user to input instructions or various information to the computer 301. A bus controller 313 arbitrates data transmitted and received between these parts.

Generally, in the personal computer 301, when a user turns on the power supply, the CPU 302 starts a program called a loader in the ROM 303, and, also, reads from the HDD 306, a program which manages the hardware and software of the computer called an operation system into the RAM 304, and this operation system is started. According to operation of the user, the operating system starts a program, reads or saves information. As a typical one, Windows, UNIX, etc. are known as the operation system. A program which runs on the operation system is called an application.

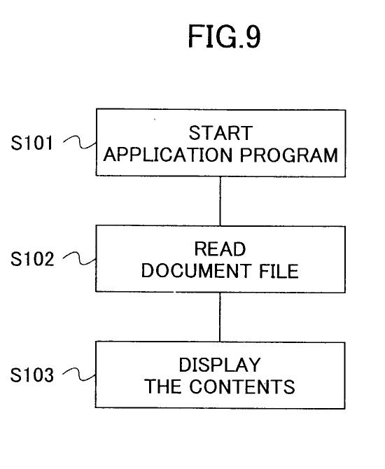

FIG. 9 shows a flow chart which shows an operation flow of a conventional document viewing processing performed by means of the personal computer 301. As in the viewing processing on a conventional document, as shown in FIG. 9, an application program for document viewing is started (in a step S101), a document file suitable to this application program is read out by the application program started (in a step S102), and thus, this is displayed (in a step S103).

Moreover, as for such processing, it is common that the application program is started in response to an operation performed by the user of clicking/pressing a displayed document file (for example, double clicking operation) by the mouse 312 for the purpose of selecting this document. That is, as the viewing processing technique for the document file in the conventional personal computer 301, in many cases, document data is read together with the relevant application program. Therefore, in order for displaying, editing, etc. to process a document contained in a document file, the application program corresponding to the document is needed.

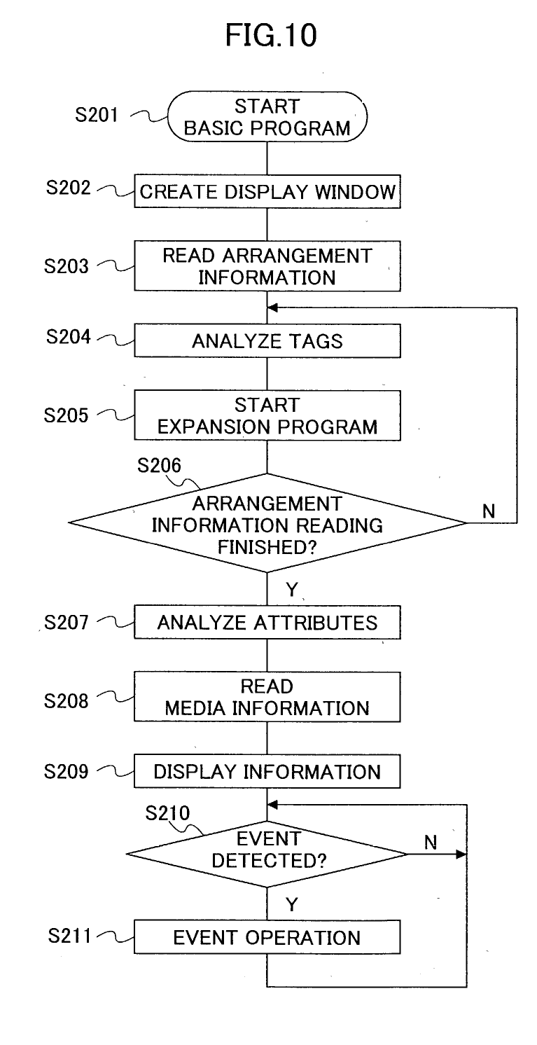

FIG. 10 shows a flow chart which shows an operation flow of document viewing processing for the encapsulated document 101 according to the embodiment of the present invention also by means of the personal computer 301.

The encapsulated document 101 includes an icon file concerning icons not shown in the figure to be displayed on the personal computer 301 for representing substance data, i.e., the text information 103 and the media information 104. Thus, the icons are displayed on the personal computer 301 according to this icon file. Then, a user performs a selection operation (double click) of an icon corresponding to the substance data of the encapsulated document 101 with the mouse 312. Then, the basic program 111 stored in the library file 201 is started (in a step S201). The basic program 111 then creates a display window for displaying a document after the starting (in a step S202). Then, the basic program 111 reads the document arrangement information 102 in the library file 201 described by XML (in a step S203).

The basic program 111 analyzes the tag structure after reading of the document arrangement information 102 (in a step S204), starts the expansion programs 112 corresponding to the tag names which is shown in FIG. 5 by other threads, and sends the attribute described in the document arrangement information 102 to each relevant expansion program 112 (in a step S205). The basic program 111 performs such processing for all the tags described in the document arrangement information 102 of the encapsulated document 101 (in a step S206). Thereby, the plurality of expansion programs 112 described by the document arrangement information 102 are started by different threads (in a step S205).

Each expansion program 112 analyzes the attribute received from the basic program 111 (in a step S207), and reads the required text information 103 or media information 104 from the library file 201 of the encapsulated document 101 according to the contents of the read attribute (in a step S208). Then, the respective expansion programs 112 display the text information 103 and the media information 104 in areas in sizes according to the attributes concerning the window which the basic program 111 creates (in a step S209). Through such processing, the plurality of sets of text information 103 and media information 104 of the encapsulated document 101 are displayed in the window created by the basic program 111.

Moreover, after such displaying operation, the expansion program 112 performs relevant processing (in a step S211) when recognizing occurrence of various events (Yes of a step S210). Thus, the encapsulated document 101 can express the document according to a basically different configuration from that in the case of conventional document.

[Description Scheme on Program of Encapsulated Document]

Description of the program 105 included in the encapsulated document 101 will now be described.

When describing the program 105, one of some schemes may be applied therefor.

The first scheme is such that a C-program language generally known is used for describing the program 105, and, a C-language compiler is used for creating native code in an executable form (exe. file in case of Windows) which the CPU 302 can directly execute. In this case, it is necessary to create the basic program 111 in an executable form (Windows exe. form), and, then, each expansion program 112 in a library form (Windows dll. form). Then, the document arrangement information 102, digital information files (the text information 103 and media information 104), and the program 105 held with the library structure are searched by means of the index or the header, as mentioned above. Thereby, the basic program 111 can be selected therefrom to be executed first as mentioned above. However, since the codes of the CPU 302 are limited to those depending on the type of the CPU 302, this scheme cannot be said to be a very superior scheme.

The second scheme is a method of using an interpreter language, such as a JAVA language. Without using executable code, a program is produced from abstract intermediate code, the CPU 302 changes this intermediate code into native code directly understandable by the CPU 302 at a time of execution, and then, the program is performed by the CPU 302. By employing this scheme, it is possible to utilize the encapsulated document 101 in a multi-platform not depending on the type of the CPU 302 is attained.

Thus, with the encapsulated document 101 in the embodiment of the present invention, the basic program 111 is started first. Then, the basic program 111 reads the respective sets of information from the document arrangement information 102, and then, operates the expansion program 112 suitable to the thus-read information.

Moreover, as mentioned above, as to the expansion program 112, a program corresponding to the type of tag of the document arrangement information 102 described by XML etc. may be prepared beforehand, and may be started. Alternatively, the expansion program 112 may be started in response to various types of digital information files (the text information 103, media information 104, and so forth) being read according to the attribute information on the tag.

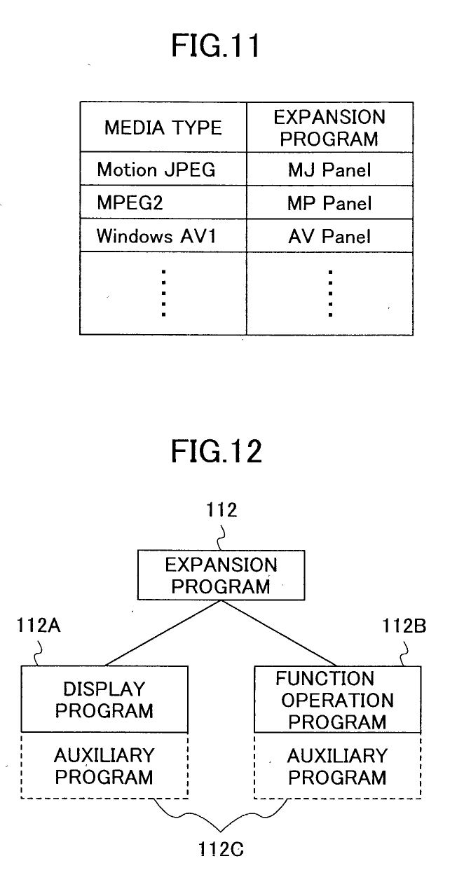

For example, as shown in FIG. 11, since there are a plurality of typical formats for reproducing an animation image, if one expansion program 112 for displaying a plurality of animations were created, it should become a large-sized program. Then, it is advantageous to prepare a plurality of expansion programs 112 corresponding respective types of file formats, and then, to simply encapsulate the expansion program 112 corresponding to the relevant specific type of file format in the encapsulated document 101.

[Expansion Program]

FIG. 12 shows typical examples in type of expansion programs 112. The expansion program 112 may not only be a digital information display program 112A for reproducing digital information but also be a function operation program 112B merely for providing a specific function without reading the digital information, as shown in FIG. 12. Alternatively, the digital information display program 112A and function operation program 112B in the expansion program 112 may have auxiliary programs 112C which assist them, respectively, as shown in the figure.

Examples of functions realized by the function operation program 112B and auxiliary program 112C will now be described.

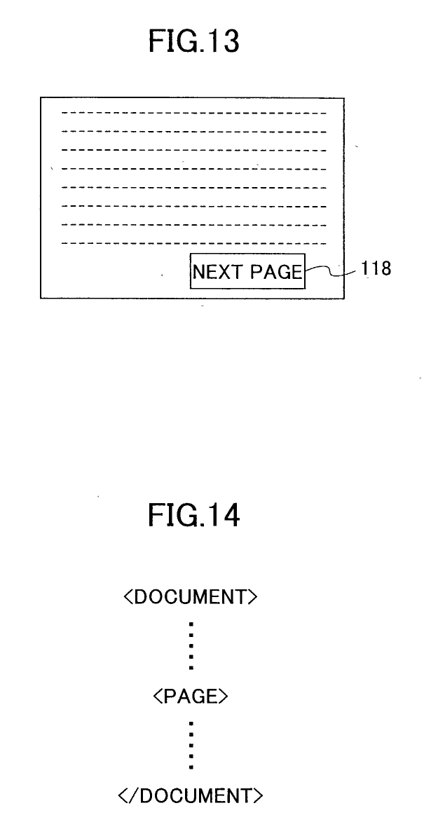

As an example, a document is assumed to be too long to be displayed on the display device 310 of the personal computer 301 at once, and thus, the document ranges over a plurality of pages. In this case, it is necessary is to create a page turning-over button 118 as a functional panel indicating “NEXT PAGE” appear on the display device 310, as shown in FIG. 13. This is realized by describing a tag <PAGE>, to the document arrangement information 102, and giving a function of the expansion program 112 called PAGE Button corresponding to this tag to the function operation program 112B, as shown in FIG. 14. By this, the function operation program 112B called PAGE Button starts, the page turning-over button 118 as shown in FIG. 13 appears in the document image, and the user may press it by the mouse 312. When the button is thus pressed, the function by which the page is turned over is effected.

When the user thus presses the button, as for the expansion program 112, this event is detected by the expansion program 112 as shown in the flow chart shown in FIG. 10 (Yes in the step S210), and corresponding event operation is thus performed (in the step S211). The event operation thus performed is the above-mentioned page turning-over function performed by the function operation program 112B and auxiliary program 112C.

As another example, the function operation program 112B by which document information is displayed, such as the number of pages, creation date, the total number of words may also be provided.

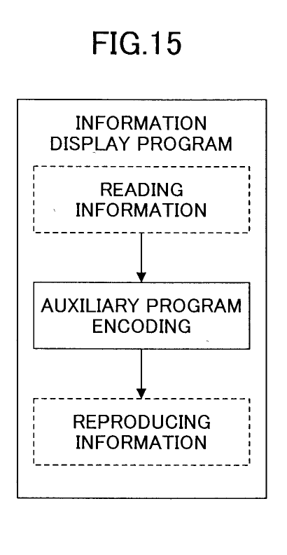

Subsequently, an example in an animation image reproduction function will now be described as an example of the function performed by the expansion program 112 and auxiliary program 112C which assists it. Since a basic display part can be used in common for any animation file formats in the animation image reproduction function, this part may be provided as a fundamental expansion program 112. On the other hand, a part thereof which depends on particular animation image file formats may be provided as the auxiliary program 112C. For example, as shown in FIG. 15, a file encoding part may be provided as the auxiliary program 112C.

Subsequently, a specific example of the expansion program 112 will now be described.

First, a function of the expansion program 112 on condition of a plurality of digital information files (the text information 103, media information 104) being included in the encapsulated document 101 will now be described.

The expansion program 112 displays a panel for file selection, which is not shown, on the display device 310. This panel for file selection is a panel listing the plurality of digital information files (the text information 103, media information 104) included in the encapsulated document 101 so as to allow a user to select one thereof. Then, when, by means of the mouse 312, or the like, a digital information file (text information 103 or media information 104) is selected, the expansion program 112 detects this event (Yes in the step S210), and performs the relevant event operation corresponding the event (in the step S211), as shown in FIG. 10.

As the event operation thus performed, the expansion program 112 displays the substantial contents of the digital information file (the text information 103, media information 104) selected as mentioned above.

Next, a function of the expansion program 112 on condition of an image file of a still image being included in the encapsulated document 101 as media information 104 will now be described.

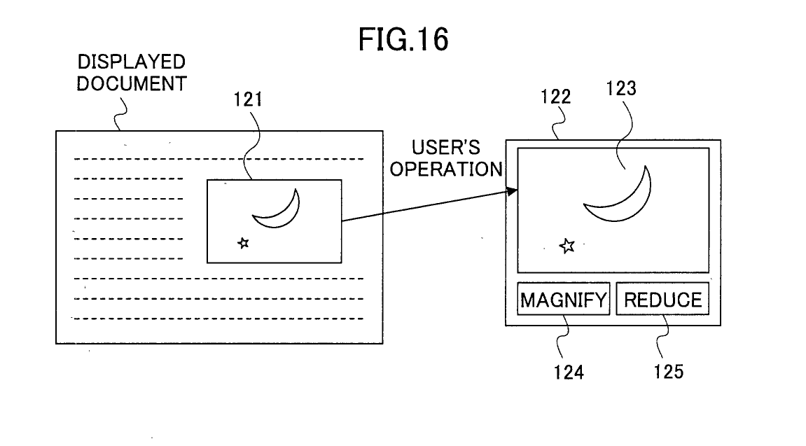

As shown in FIG. 16, the expansion program 112 displays a still image 121 in a document currently displayed on the display device 310. Then, when selection instructions are input for a display area of an still image 121 contained in the document shown in the display device 310 by means of the mouse 312, etc., the expansion program 112 detects this event (Yes of in the step S210), and performs corresponding event operation (in the step S211), as shown in the flow chart shown in FIG. 10.

As the event operation thus performed, the expansion program 112 creates and indicates a functional panel 122 which is another frame especially for magnification/reduction display, as shown in FIG. 16. This functional panel 122 has a magnification button 124 and a reduction button 125 together with a magnified/reduced still image 123. Then, the expansion program 112 changes the magnification rate/reduction rate in response to instructions given by a user by pressing the magnification/reduction button 124/125.

By adding such a new function to the expansion program 112 which displays a still image, it is possible to improve user's controllability on a displayed image, compared with merely inserting the still image 121 into the displayed document.

Such magnification/reduction function performed by the expansion program 112 is realizable by any well-known image magnification/reduction function.

Next, a function of the expansion program 112 on condition of a solid image file being included in the encapsulated document 101 as media information 104 will now be described.

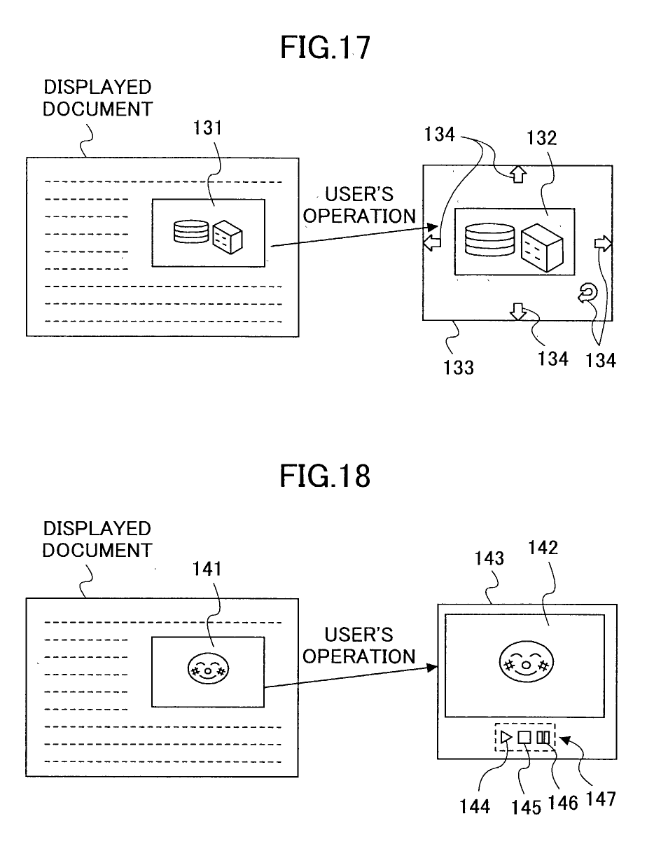

As shown in FIG. 17, the expansion program 112 displays a solid (3D) image 131 in a currently displayed document on the display device 310. Then, when selection instructions are given to a display area of the solid image 131 contained in the document on the display device 310 by means the mouse 312, etc., the expansion program 112 detects this event operation (Yes of in the step S210), and performs the corresponding event operation (in the step S211), as shown in the flow chart shown in FIG. 10.

As the event operation thus performed, the expansion program 112 displays a pop-up frame 133 which contains a magnified, reduced, or same-size image 132 as the solid image 131, and provides buttons 134 for viewpoint change for changing viewpoint, on this pop-up frame 133. Then, the expansion program 112 changes the viewpoint on the solid image 131 according to instructions given through the buttons 134 for viewpoint change by a user by means of mouse click or the like.

Thereby, a user's visibility can be improved. Next, a function of the expansion program 112 on condition of an animation image file being included in the encapsulated document 101 as media information 104 will now be described.

As shown in FIG. 18, the expansion program 112 displays a still image 141 specified by one frame of an animation image into a document currently displayed on the display device 310. Then, when selectively pointing instructions are given to a display area of the still image 141 contained in the document on the display device 310 by mouse click or the like, the expansion program 112 detects this event (Yes of in the step S210), and performs the corresponding event operation (in the step S211), as shown in the flow chart shown in FIG. 10.

As the thus-performed event operation, the expansion program 112 displays a pop-up frame 143 which contains a magnified, reduced, or same-size image 142 as the still image 141, and provides operation buttons 147, i.e., a reproduction button 144, a stop button 145, a pause button 146 to this pop-up frame 143. Then, when any one of the operation buttons 147 is pressed by mouse click or the like, the expansion program 112 detects the event (Yes in the step S210), and performs the corresponding event operation (in the step S21), as shown in the flow chart of FIG. 10.

Specifically, when the reproduction button 144 is pressed, the event operation is performed as follows: The expansion program 112 causes the image 142 currently displayed as a still image to be reproduced as the original animation image. When the pause button 146 is pressed, the reproduction of the animation image is stopped. When the stop button 145 is pressed, the reproduction of the animation image is made then to display a still image at the time.

Furthermore, a function of the expansion program 112 on condition of a voice information file being included in the encapsulated document 101 as media information 104 will now be described.

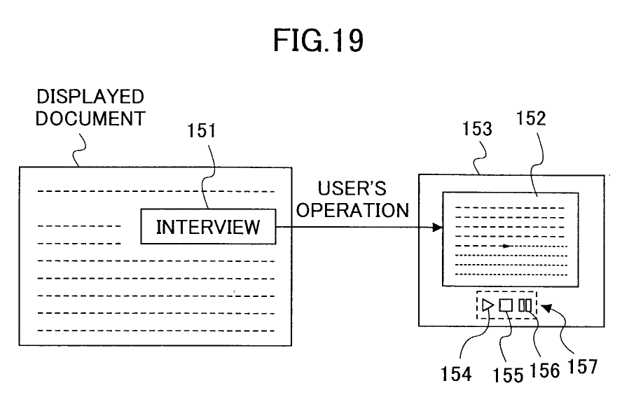

As shown in FIG. 19, the expansion program 112 displays a voice reproduction button 151 as a functional panel and a reproduction panel into a document currently displayed on the display device 310. Then, when pointing instructions are given by a user to a display area of the voice reproduction button 151 contained in the document on the display device 310 by means of mouse click operation, the expansion program 112 detects the event and performs the corresponding event operation (Yes in the step S210 and in the step,S211, shown in FIG. 10).

As the event operation thus performed, the expansion program 112 displays a pop-up frame 153 including a voice reading-out information display area 152, and operation buttons 157, i.e., a, reproduction button 154, a stop button 155, and a pause button 155 to this pop-up frame 153.

Then, when the reproduction button 154 is pressed, the expansion program 112 reproduces the sound in the voice information file included in the encapsulated document 101. When the pause button 146 is pressed, the program 112 stops the voice reproduction in the voice information file under reproduction. When the stop button 145 is pressed, the program 112 stops the voice reproduction in the voice information file under reproduction at the time.

Furthermore, the expansion program 112 may make the personal computer 301 perform a function of displaying visible information obtained from converting the sound reproduced into text information on the display area 152, when the reproduction button 154 is pressed. Such operation may be effective, in case the document is viewed on condition a speaker for voice reproduction of the document viewing device (for example, the personal computer 301 itself) is turned off, or in case a deafness person views the document. Such a reading-out function may be started automatically based on a predetermined setting made beforehand of the speaker, a predetermined handicapped person assistance function, or the like.

The above-mentioned voice information file may have a data structure as voice data obtained from sampling a sound, or merely text data. When it is text data, it can be reproduced by a technique of changing text into voice data determined, for example, by an audio feature amount using a voice synthesis LSI, etc. Above-mentioned conversion of voice information into text information may be performed by using text data as it is in case the voice information file is formed of the text data as mentioned above. On the other hand, when the voice information file is constituted by voice data, processing of analyzing the voice data and converting it into text data is needed.

Other than the above-mentioned various examples, it is also possible to prepare many types of expansion programs 112 for the encapsulated document 101 according to the characteristic of various types of digital information which is desired to be displayed or reproduced. Then, the expansion programs 112 corresponding to various media are flexibly realizable by preparing these expansion programs 112 as parts of the multimedia documents. Since it is necessary to store only the expansion program 112 required in the encapsulated document 101 in this embodiment, handling of the encapsulated document 101 becomes easier.

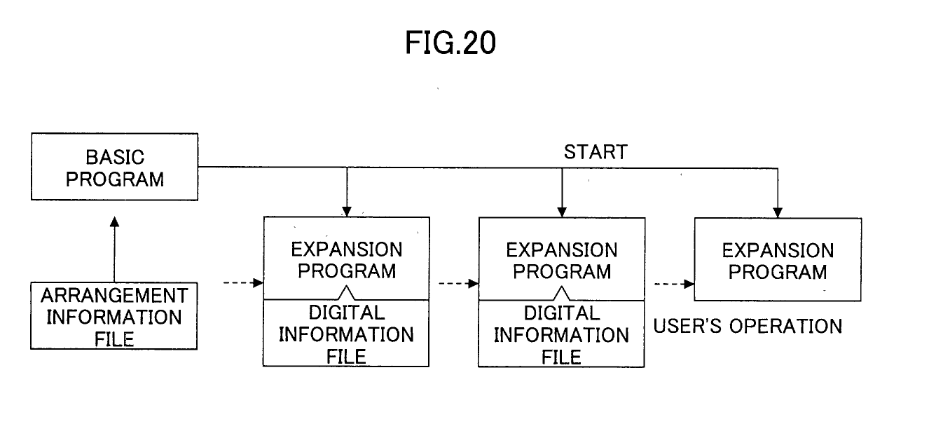

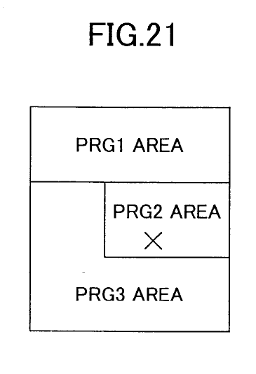

FIG. 20 shows a structure of the expansion programs 112 included in the encapsulated document 101. In the encapsulated document 101 of this embodiment, the basic program 111 reads the document arrangement information 102, and the basic program 111 starts the expansion program 112 corresponding to the digital information file (the text information 103 or media information 104) which the document arrangement information 102 indicates, and starts display reproduction of the digital information file (the text information 103, or media information 104) by means of the expansion program 112 thus started. Moreover, each expansion program 112 performs corresponding operation, when user's operation is detected, respectively. In this case, when the expansion program 112 has no function of referring to the digital information file (the text information 103, or media information 104), user's operation is received, and then, operation according to the user's operation is carried out accordingly. The user's operation may be an operation of clicking the mouse 312, finger operation on the keyboard 311, etc. In case of mouse click operation, it is determined whether a predetermined display area for the expansion program is pointed thereby, and, when this area is pointed and clicked. Then, this program performs the relevant operation. In case of keyboard operation, it is determined whether or not a cursor position movable according to key operation is positioned within the predetermined display area. For example, in a case of a document which includes three digital information files (PRG1, PRG2, and PRG3) as shown in FIG. 21, in case of applying mouse click operation, when the mouse is clicked in condition in which the cursor is positioned as indicated by the X mark in the figure, i.e., within the display area of PRG2, the expansion program 112 of PRG2 detects the click of mouse 312, and performs the corresponding operation.

Thus, the document form of the encapsulated document 101 according to the embodiment includes the group of expansion programs 112 relevant to the types of respective media, or the types of tags of the display information file, and, at least, includes the basic program 111 and the document arrangement information 102. The encapsulated document 101 has the expansion program added thereto which responds to information which a user wants to store in the encapsulated document 101, and prepares a digital information file (text information 103 or media information 104), and reproduces/displays the information. The encapsulated document 101 in the embodiment of the present invention holds such various files as a single file using a well-known archive form.

[Communication Function Using Expansion Program]

Subsequently, a communication function using the expansion program 112 will now be described.

This communication function is a function to perform communication between the encapsulated documents 101 starting in a plurality of personal computers 301 connected through a network 309, respectively.

Although communication of the encapsulated document 101 will be described, it is not necessarily indispensable that it is the encapsulated document 101 for realizing the communication function. However, it is more useful to realize in the encapsulated document from viewpoint that the function is added by the above-mentioned expansion program 112.

According to the present embodiment, the communication function may be added to the encapsulated document 101 described above. In this case, a tag of XML for describing the communication function is determined as <com/>, for example. For example, the basic program 111 starts the expansion program 112 which has the communication function when this tag is read, and the expansion program 112 displays on the display device 310 a communication button which has not been shown in the currently displayed encapsulated document 101.

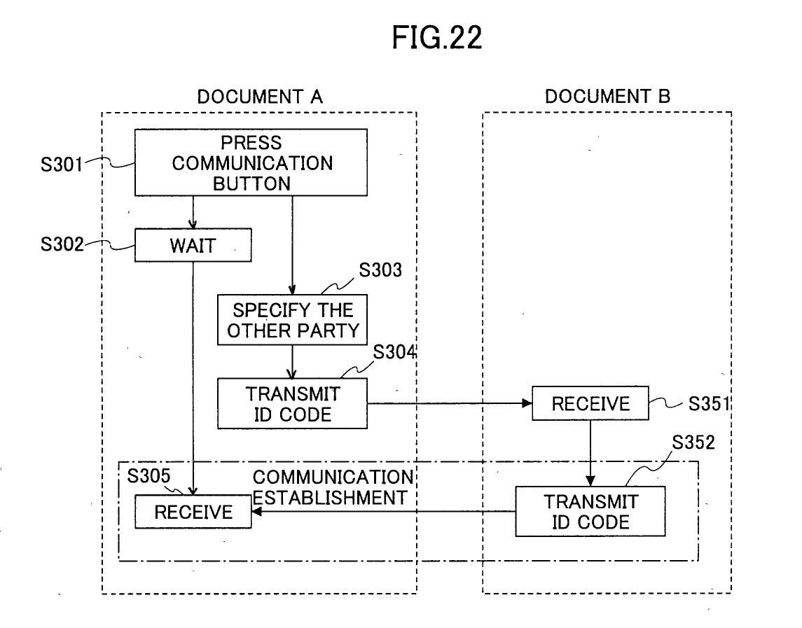

FIG. 22 is a flow-chart which shows an operation flow of creating communications between the encapsulated documents 101 in one-to-one manner. In this example, creation of communications is made between two encapsulated documents 101 referred to as documents A and B starting in different terminals A and B, i.e., two personal computers 301, respectively.

In the document A started at the terminal A, when the expansion program 112 determines that the communication button is pressed (in a step S301), a socket is opened and thus, a state of waiting for communications is entered (in a step S302). At this time, a port used may be common among respective documents.

Next, for specifying the document B started at the terminal B which is a communication partner (in a step S303), it transmits an own document identification code 401 (In a step S304). The processing in the step S304 may be performed by another thread.

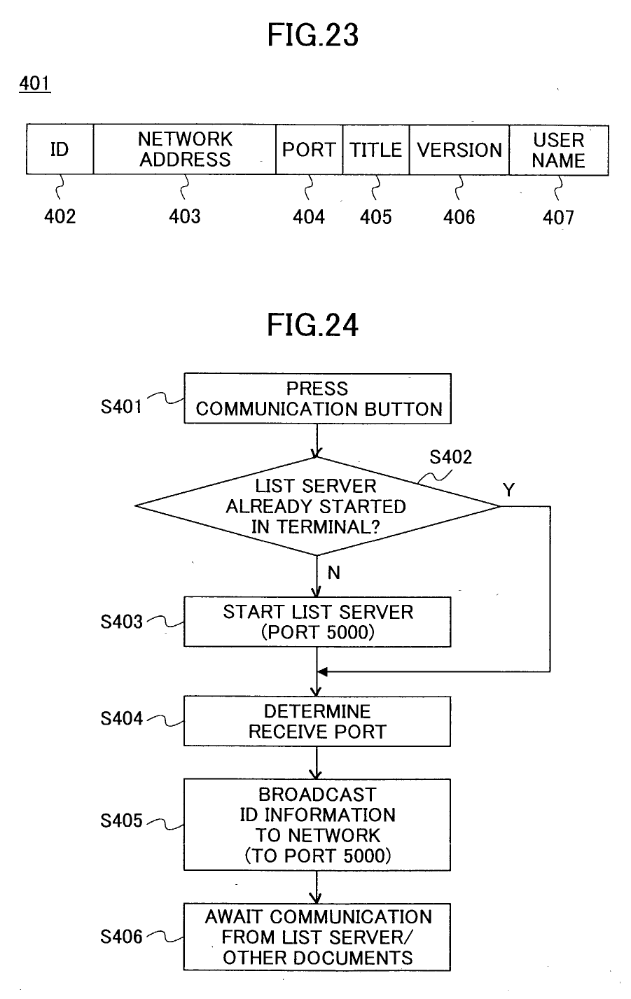

FIG. 23 is a typical example of the document identification code 401. The document identification code 401 is an identification code, and includes an ID number 402, a network address number (IP address) 403, a port number 404, a title 405, a version 406, and a user name 407.

Then, in the document A, the network address number (IP address) 403, or the user name 407 may be used for identifying the document B.

Then, when the document B is in a state in which it can receive, the document B receives a communication establish request from the document A (in a step S351). The document B which has received the communication establish request from the document A registers the document A as a communication partner, and transmits the own document identification code 401 to the document A (in a step S352). The document identification code in this case may includes the network address number (IP address) 403, user name 407 or another information of the document B.

Then, the document A receives the document identification code 401 of the document B transmitted from the document B (in a step S305), and thereby, communications are established between the document A and document B.

FIG. 24 is a flow chart which shows an operation flow of establishment of communications between a plurality of encapsulated documents 101. The establishment of communications between a plurality of encapsulated documents 101 depends on a list server which is one function of the personal computer 301 placed on a communication network. Detailed functions and operations of the list server will be described later.

In response to the communication button currently displayed on a certain encapsulated document 101 displayed being clicked as shown in FIG. 24 (in a step S401), it is determined (in a step S402) whether or not a list server as a communicatable document control program contained in the expansion program 112 is started in the personal computer 301 having the encapsulated document 101 started therein. When the list server has not been started (No), it is started (in a step S403).

Then, a port to be used is determined as of No. 5000 on the list server. The own reception port for the document is also acquired arbitrarily (in a step S404). This port is a port for document state acquisition, and in case of starting a plurality of communicatable encapsulated documents 101 in the same personal computer 301, different numbers should be assigned for the respective encapsulated documents 101. The list server's port is a port for reception of the document identification code 401, and has a port number common to each personal computer 301.

The encapsulated document 101 broadcasts its document identification code 401 (IP address 403, the port number 404, a title 405, a version 406, user name 407, etc.) via the list server's port (here, “5000”) including the port number for document state reception through the network (in a step S405). The broadcasting is performed in such a manner that the identification code is transmitted to an IP address, 255.255.255.255 as a broadcasting address, and the identification code is transmitted to all the personal computers 301 in a sub network. The purpose thereof is notification of the document identification code 401 to all the personal computers 301, and the broadcasting address should not be used necessarily. At this time, the IP addresses may be specified one by one, and be transmitted.

When communications are established by choosing one personal computer 301 not only the inside of the sub network but on the network 309, a network address, such as a host name or an IP address, may be specified, and the document identification code 401 may be transmitted thereto. By performing the above-mentioned series of processing, the encapsulated document 101 enters a state in which communications of the document state can be received by the particular port number of the list server (in a step S406). Moreover, the list server which has received the notice by the broadcasting adds the thus-received identification code to the own list.

The list server manages the communicatable encapsulated document 101 in each personal computer 301. In this case, the list server has a function of grasping all the encapsulated documents 101 which can perform communications on the network. Moreover, the list server does not start, when the other list server has already started on the personal computer 301 in which the encapsulated document 101 has started. This is because, when the plurality of communicatable encapsulated documents 101 are started in one personal computer 301, if each encapsulated document 101 grasped all the communicatable encapsulated documents 101 on the network, the same information would be managed delicately, and, thus, loads would be increased uselessly. In order to avoid such a situation, only one list server is started in one personal computer 301. Thereby, it is possible to concentrate the load of document management at the time of starting the plurality of encapsulated documents 101 into only one encapsulated document 101.

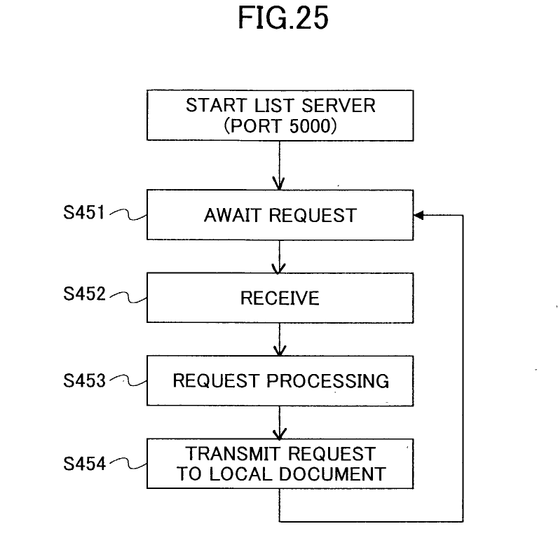

FIG. 25 is a flow chart which shows an operation flow of processing of the list server. The list server awaits various requests (identification code data) (in a step S451). Examples of the various requests are a participating request, a leaving request, a list addition request, etc.

These requests are specified as a state ID given to the header of data. Then, the list server processes by determining the type of request based on the state ID, when the request is received (in steps S452 and 453). Then, for example, when the participating request is received, the list server notifies the participating request to the encapsulated document 101 having the same version and same title as the encapsulated document 101 which has originally issued this participating request locally (in a step S454).

When the personal computer 301 which has started the local encapsulated document 101 receives this participating request, it adds the encapsulated document 101 which has thus notified this request into its own list as a communicatable encapsulated document 101. When there is the leaving request given, by the contrary, the relevant encapsulated document 101 is deleted from the list.

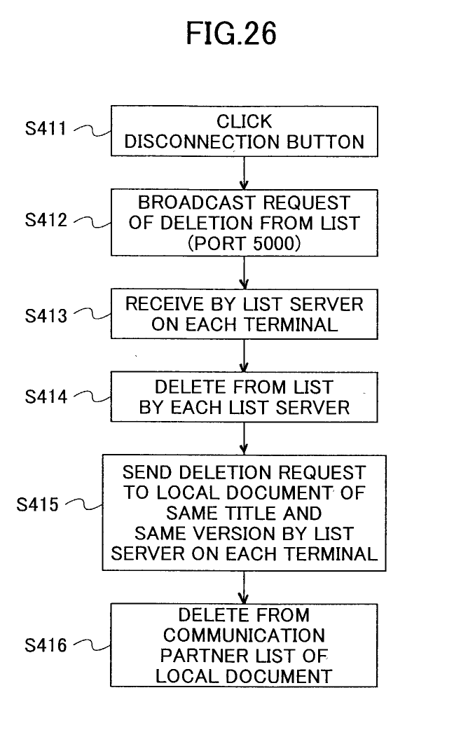

FIG. 26 is a flow chart which shows an operation flow of processing (processing at the time of leaving) which cuts communications between the plurality of encapsulated documents 101. When a cutting button is clicked in the encapsulated document 101 displayed under startup in the personal computers 301 (in a step S411), a deletion request from the list is broadcast (in a step S412), and when the list server of each personal computer 301 receives this request (in a step S413), each list server deletes the encapsulated document 101 on which the cutting button was clicked from the list of communicatable encapsulated documents 101 (in a step S414). Thereby, the list server of each personal computer 301 gives the deletion request to the local documents having the same title and same version (in a step S415), and deletes the relevant document from the communication partner lists on each local document (In a step S416).

A case where a terminal C (personal computer 301) is added in a state in which these terminals A and B (personal computers 301) communicate with one another will now be described. In this case, by receiving the document identification code 401 broadcast from the terminal C, the terminals A and B recognize that the terminal C has been added thereto. However, the terminal C does not recognize which encapsulated document 101 is communicatable at the time. Then, the list server also has a function of transmitting the list of the encapsulated documents 101 communicable at the present time to the personal computer 301 which has sent the participating request.

The above-mentioned list means a collection of the document identification codes 401 unique to the documents exchanged at a time of communication. In this case, responses may be sent out from all the personal computers 301 in each of which the list server has been started on the network. However, since each terminal (list server) has the list of the communicable documents on the network, answering from all list servers is useless or redundant. Therefore, as load mitigation of the network is considered, one personal computer 301 is chosen therefrom by a certain method, and the list is transmitted therefrom to the personal computer 301 which has sent the participating request newly. As the above-mentioned certain method, the personal computer 301 with the IP address near the personal computer 301 which has sent the participating request may play the role of sending the list. Exchange of the data may be performed using standard protocols, such as UDP or TCP/IP.

By the above processing, the list of documents which can communicate can be created on each encapsulated document 101. By displaying this list as, for example, synchronization buttons into the encapsulated document 101 displayed, in response to the button being clicked, synchronization with the relevant encapsulated document 101 can be attained. Moreover, a button by which all the encapsulated documents 101 that can communicate are synchronized is also provided.

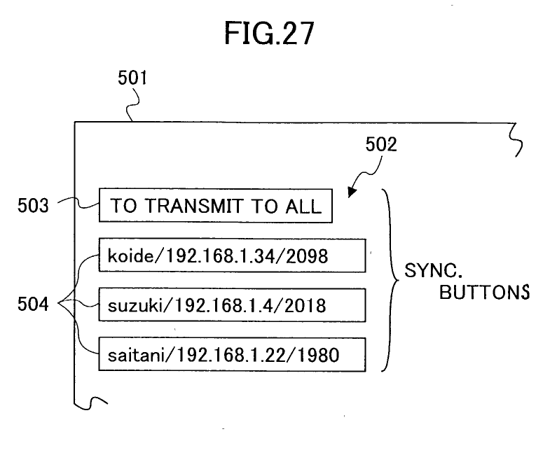

FIG. 27 shows a typical view showing an example of the synchronization buttons displayed into the document panel of the encapsulated document 101. The list of transmitting communicatable documents is displayed as the synchronization buttons 502 on the document panel 501 which appears in the display image of the encapsulated document 101, as shown in FIG. 27. The top all-selection button 503 currently displayed as “TO TRANSMIT TO ALL” of the synchronization buttons 502 is a button by which transmitting to all the encapsulated documents 101 that can communicate are selected. Buttons 504 below it of the synchronization buttons are those by which transmitting to respective corresponding encapsulated documents 101 are attained.

Although indication of these individual selection buttons 504 is made with a form of a user's name/IP address/port number in the example shown in FIG. 27, other various types of indications may be applied instead. For example, as one idea, only user name may be always indicated, and, indicating a network address may be made only when the mouse cursor comes on the button; a host name may be indicated; or, the button may be replaced by a user's image, video, or the like, for example. Moreover, in order to make possible where the information which the encapsulated document 101 has received was sent from, a button which indicates the person who sent it may be highlighted, for example.

When the all-selection button 503 or one of the individual selection button 504 is clicked, a document state of the encapsulated document 101 is transmitted to the relevant encapsulated document(s) 101, thereby the document being synchronized therewith. The exchange of the document state is performed directly by utilizing a pair of the IP address in identification code and the port number for document state reception which each document has. Thus, the list server does not play any role in the exchange of the document state.

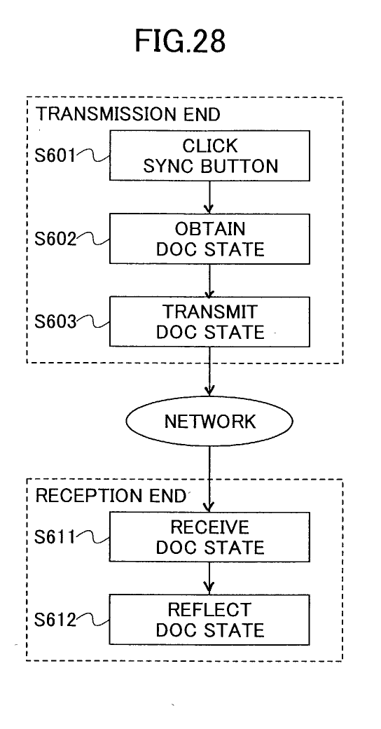

FIG. 28 shows an operating flow chart of processing performed in response to the synchronization button 504, i.e., the all selection button 503 or individual selection button 504 being pressed/clicked. First, when the synchronization button 502 which is the all selection button 503 or the individual selection button 504 is clicked (in a step S601), the expansion program 112 in the encapsulated document 101 detects this event in the step S210 of FIG. 10 (Yes in the step S210), and performs processing according to the detected event (in the step S211). The processing according to the event in this case is sending out of information collection request.

That is, in the personal computer 301 which transmits the information collection request obtains the document state of the encapsulated document 101 which is under startup in the own personal computer 301, by processing of the expansion program 112 (In a step S602). This document state means a collection of information concerning the state of the encapsulated document 101 currently displayed on the personal computer 301 indicating that, for example, a page ‘a’ of the document is displayed, an image is popped up at the coordinate (x, y), etc. Then, the expansion program 112 transmits the thus-obtained document state through the network to the relevant personal computer 301 having another encapsulated document 101 started therein, using a standard protocol (In a step S603).

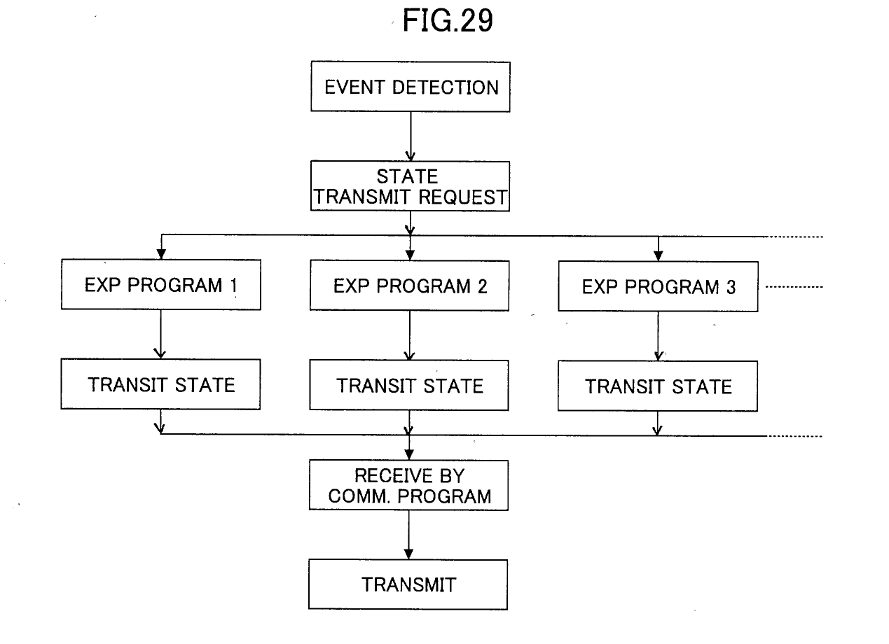

FIG. 29 shows a typical view again showing pluralistically the processing shown in the flow chart of FIG. 28. When the expansion program 112 carries out the event detection caused by click of the synchronization button 502 by a user, i.e., the all selection button 503 or individual selection button 504, the expansion program 112 executes the state transmission request. Thereby, as shown in FIG. 29, the expansion programs 1, 2, 3, . . . , which are modules of the expansion program 112 perform state transmission. The thus-transmitted state information is received by communication programs, i.e., modules in the expansion program 112, and then, which in turn perform transmission thereof through the network.

Then, returning to the flow chart of FIG. 28, the personal computer 301 which receives the information receives the thus-transmitted state information (in a step S611), and, based thereon, reflects the thus-obtained information onto the display image of the encapsulated document 101 already started and currently displayed there.

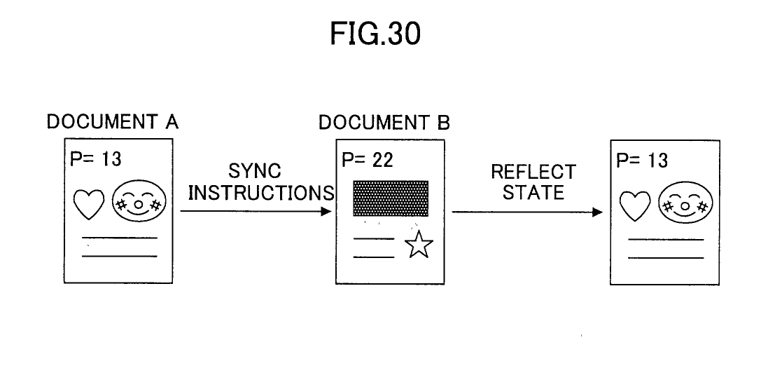

FIG. 30 shows a typical view showing a state where two encapsulated documents 101, i.e., a document A and a document B synchronize. These documents A and document B are the encapsulated documents 101 same in contents. The document A started on one personal computer 301 displays the 13th page (P13) of the document for example, while the document B started on another personal computer 301 displays the 22nd page (P22) of the document for example. In this state, when the document state information is sent from the document A to the document B, it is received by the document B, the state is reflected there, and the display of the document B becomes the 13th page (P13) same as the display on the document A.

Such synchronization processing may be performed on real time. That is, in the example of the processing mentioned above, when the synchronization button 502 is pressed (or detached), this action is detected as an event, the collection request for document state information is sent to each expansion programs 1, 2, 3, . . . included in the expansion program 112. Instead thereof, a release occasion after a certain action, for example, a mouse click to be performed for initiating page turning over, image display, image magnification, or the like, may be detected as an event. Then, the collection request for document state information is given to each of the expansion programs 1, 2, 3, . . . , included in the expansion program 112 based on this detection, and the communication program which the expansion program 112 includes receives this and transmits the relevant document state information similarly to the above. Thereby, it is also possible to always cause synchronization at a time of each event generation.

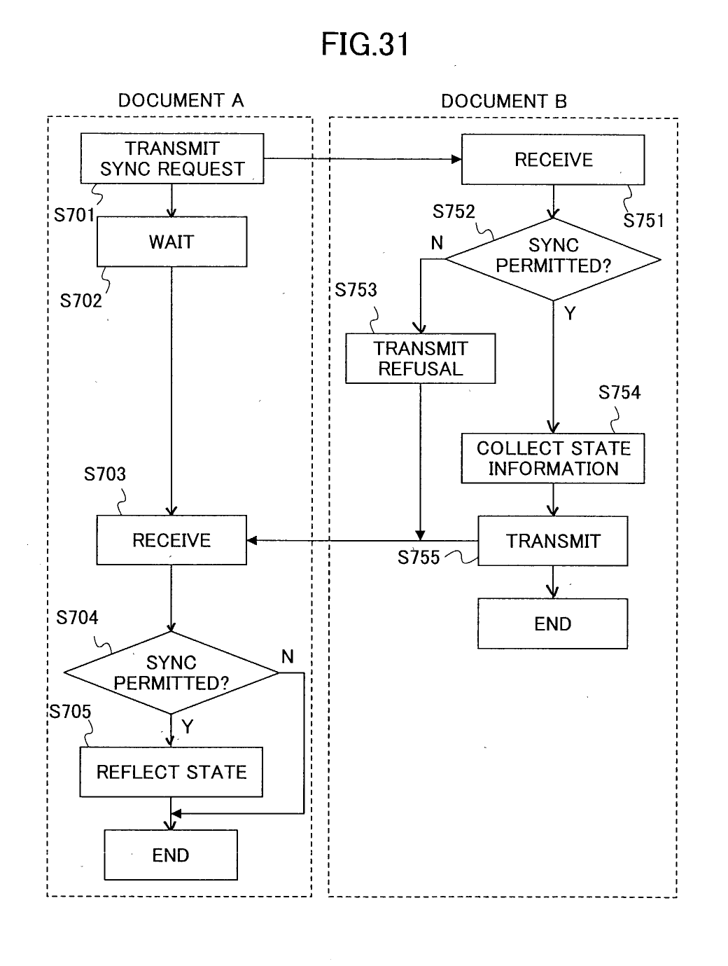

It is also possible that, in execution of the synchronization processing, selection can be made by a user as to whether or not synchronization should be actually made, on the encapsulated document 101. FIG. 31 shows such a flow chart that shows an operation flow of selective synchronization processing.

First, a synchronization request is given from the document A to the document B (in a step S701). The IP address, host name, user name, or the like on the document B may be used for the indication of the document B.

This request is received (in a step S751), a popped-up window which enables selection as to whether or not this synchronization request is permitted, not shown in the figure, is displayed to the user who started and views the document B on a personal computer 301, and the user is made to choose whether the relevant synchronization request is permitted by the user (in a step S752). When the user refuses this synchronization request (No of in the step S752), this refusal intension is transmitted to the document A (In a step S753). On the other hand, when the synchronization request is permitted (Yes of the step S752), the document B acquires the document state information of its own (in a step S754), and this is transmitted to the document A (in a step S755).

After the document A gives the synchronization request to the document B (in the step S701), it enters a waiting state (in a step S702), and then, it receives data of the document state information meaning synchronization request permission by the step S755 or the synchronization request refusal by the step S753 from the document B (in a step S703). Then, the document A make a display of the document reflecting the thus-received state, when the received data includes the document state information (in a step S704). Otherwise, “the synchronization was refused”, etc. is displayed, and the state of document currently displayed is left as it has been.

Thus, it becomes possible by taking synchronization of the encapsulated documents 101 in a plurality of personal computers 301 to exchange the information between the encapsulated documents 101. For example, in a remote meeting performed by means of a plurality of personal computers 301 on which a plurality of encapsulated documents 101 are started up, when a speaker of the meeting participants wishes to show a certain page of the document to all the other participants, the speaker may open the page and click the synchronization button 502. Thereby, the same page is made to open in all the other encapsulated documents 101 including the same contents on the participants, and, thus, sharing or collaboration of the information among the participants becomes possible.

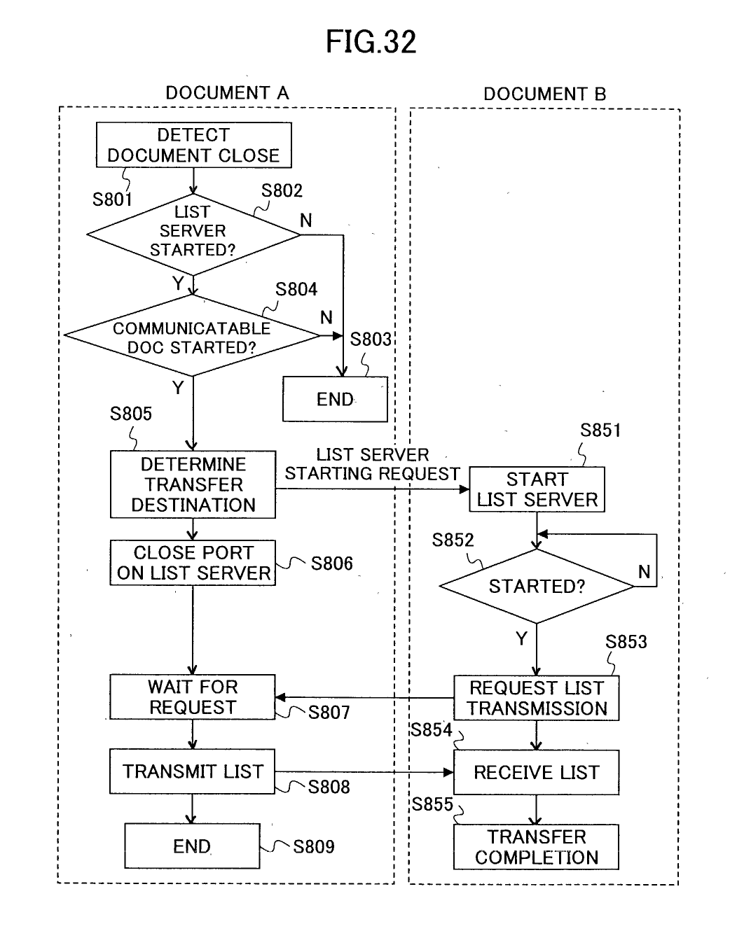

FIG. 32 is a flow chart which shows processing for list server's transference. As mentioned above, only the single list server starts on each personal computer 301. Therefore, when the plurality of encapsulated documents 101 perform communication function and have become on-line, the list server starts by the program included in the encapsulated document 101 which was made on-line first. Since the list server has an important role to manage the encapsulated documents 101 which can communicate on the network, when the encapsulated document having the list server started therein is closed, the function of the list server should be transferred to another corresponding encapsulated document 101 in the on-line state on the network which can be viewed on the personal computer 301 which has the relevant encapsulated document started therein. Hereafter, the details of the processing will be described.

As shown in FIG. 32, it is assumed that the list server is started in the document A. When an action for the purpose of closing the document A is detected in this state (in a step S801), first it is determined whether or not the list server has started by the own expansion program 112 (in a step S802). This determination may be easily made by determining as to whether or not the port for the list server is used by the own expansion program 112. Consequently, when the list server has not been started by the own expansion program 112 (No of the step S802), no substantial operation is performed (in a step S803). On the other hand, transference processing is started when it has been started by the own expansion program 112 (Yes of the step S802).

In the transference processing, in order to find a destination partner to which the transfer is to be made, it is determined as to whether there is any other on-line document in the own personal computer 301 (in a step S804). This determination can be easily made by checking the communicable document list of its own (list server). When no encapsulated documents 101 which can communicate can be found in its own personal computer 301 (No of the step S804), the processing is ended as it is (in a step S803). Otherwise (Yes of the step S804) a transference destination is determined out of the thus-found other encapsulated documents 101 in the own personal computer 301 which can be communicated (in a step S805). Any method for this determination may be applied, for example, the one located at th first place in the list may be selected, for example. After the transference destination is determined, a list server starting request is transmitted to this document. The transmission destination in this case is defined by a pair of the IP address of the own personal computer 301 (local) and the unique port number on the encapsulated document 101 to which the transfer is made.

The document B used as the transference destination receives it, and tries to start the list server (in a step S851).

On the other hand, the port of the list server is closed by the document A (in a step S806), and enters a state of waiting for a request (in a step S807).

Then, the document B, repeats the trial for starting the list server until the list server's port is closed by the document A, since the port of the list server cannot be opened by the document B as long as the same port is used by the document A. As a form of another operation for such processing, another port of the list server may be provided, and, then, the two ports may be used temporarily. When the list server is started by the document B (Yes of the step S852), the transmitting request for the list is transmitted to the document A (in a step S853).

The document A receives it, and sends the list which the list server started from the document A holds is transmitted to the list server of the document B (in a step S808). The document A is actually closed after the transmission (in a step S809).

Thus, the document B adds the communicatable document list sent from the document A to the own list. Thereby, the list server transference is completed (in a step S855).

[Summary Display Using Expansion Program]

A document summary function mainly realized by the expansion program 112 will now be described. The document summary function can be achieved by providing a summary program as the expansion program in the program 105, by preparing information needed for summary, i.e., the text information 103 and so forth, and, also, by utilizing various summary production method.

FIG. 22 shows, similarly to FIG. 7, a typical view showing an example of a display image of the encapsulated document 101 described by XML, as shown in FIG. 6, and a different point from FIG. 7 is a point that a summary button 1401 is displayed.

The encapsulated document 101, as shown in FIG. 22, is displayed based on description of XML as illustrated in FIG. 6. First, a tag <Document> showing the whole document is described, and the structure of the document is described there. Then, in order to describe the title first, the contents of display in case of using a tag <TEXT> are those enclosed by the tag, when absolute is omitted. A next example of the following TEXT tag is an example for reading text information from a file “BODY. TXT.” The following IMAGE tag is the arrangement information for a still image “IMAGE. JPG” to be displayed in such a size that according to WIDTH and HEIGHT with the X and Y coordinate as the starting point.

Thus, the document arrangement information 102 provides instructions for a file to be referred to, and instructions for the display arrangement according to the XML form, as described above.

Although the document arrangement information 102 utilizes the XML form for an example as mentioned above, other description languages, such as an HTML form, may also be used instead, or, an original description form may also be used instead.

The media information 104 may include a still image, an animation image, a 3D image, voice information, etc. A common file format may be used for managing the information/data. In case of a special specification employed, an original format may also be prepared and then, used.

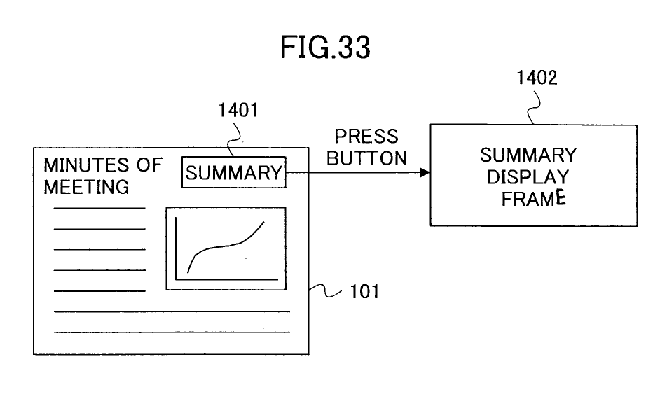

By clicking the summary button 1401 contained in FIG. 33, a summary frame 1402 for displaying summary information on the text information read from the file “BODY .TXT”, on the displayed image. Then, summary information is displayed on this summary frame 1402.

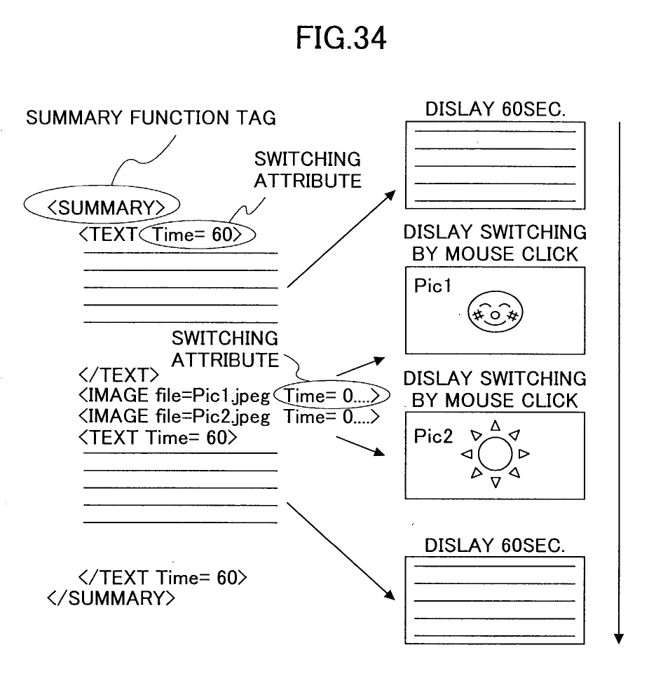

FIG. 34 shows a typical view showing an example of the document arrangement information 102 for arranging the summary information. The summary function tag <SUMMARY> for describing a summary display as shown in FIG. 34 is indicated in the document arrangement information 102, and the summary information which is a display element is described under this summary function tag.

When there are a plurality of display elements, an attribute which switches display thereof is added for each display element. For example, in the example shown in FIG. 34, only during a time indicated by an attribute ‘Time’, the relevant display element is displayed, by using the attribute ‘Time’. When ‘Time’ indicates 0, the display is terminated by detection of an operation made by a user's mouse click, etc. Thus, a display of the whole summary information is enabled by switching the display sequentially, and, thus, a summary of the contents of the relevant document is displayed.

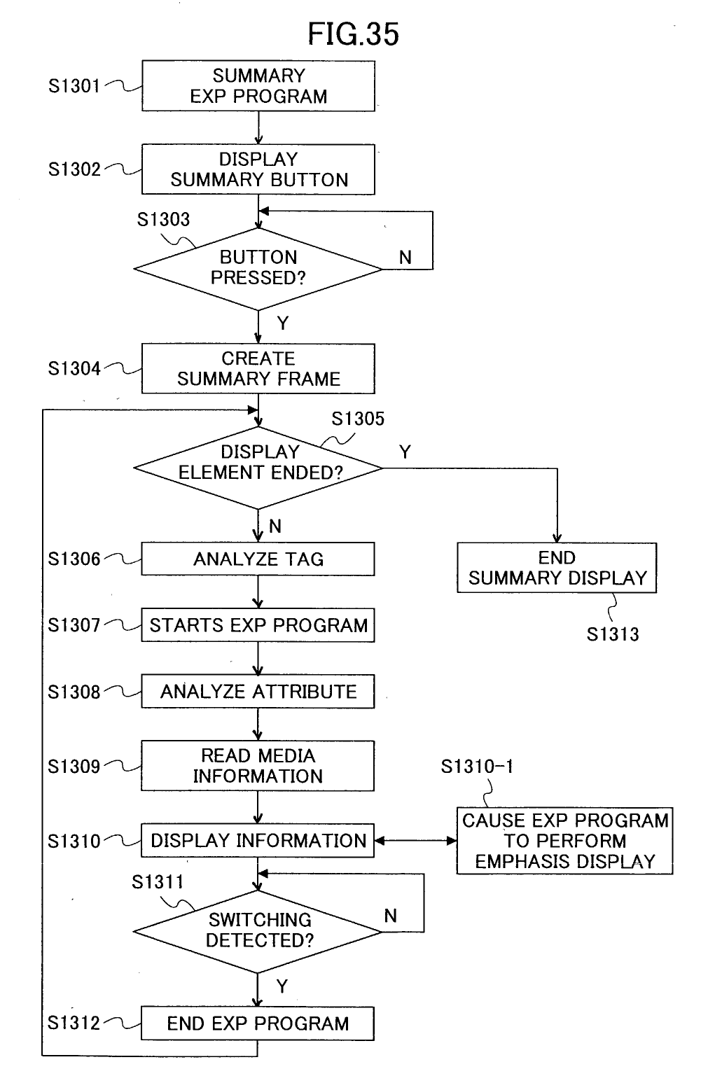

FIG. 35 is a flow chart which shows an operation flow of processing by the expansion program 112 for the above-mentioned summary display. The expansion program 112 here is a summary extension program for displaying a summary. Therefore, summary information included in the document arrangement information 102 is displayed on the display device 310 by the function of the expansion program 112 as this summary expansion program. The processing will now be described.

First, when the expansion program 112 which has a summary function is started based on the document arrangement information 102 from the basic program 105 in the encapsulated document 101 (in a step S1301), a summary button 1401 showing a summary function is displayed in a display image of the document (in a step S1302). Then, until a user presses the summary button 1401, a waiting state is held (in a step S1303).

The expansion program 112 creates a summary frame 1402 for a summary display in addition to the display image of the document, when it is detected (Yes of the step S1303) that the user presses the summary button 1401 (in a step S1304). Then, description of each above-mentioned display element is analyzed (in a step S1306), and the expansion program 112 corresponding to each display element is started based on the analysis result until the processing on each display element contained in the document arrangement information 102 is completed (in steps S1305 through S1307).

The started expansion program 112 analyzes the above-mentioned attributes received from the basic program 111 (in a step S1308), and reads relevant text information 103 and media information 104 from the library file 201 in the encapsulated document 101 according to the contents of the thus-read attribute (in a step S1309).

Thereby, the expansion program 112, based on the description on each display element obtained from the document arrangement information 102 in the library file 201, displays the respective display elements for the summary frame in the summary display (in a step S1310). Then, elapse of time, or switching action is monitored based on the analyzed attribute (in a step S1311), and, when occurrence of any event is detected (Yes of the step S1311), execution of the expansion program 112 for the display element is terminated (in a step S1312).

At this time, in the step S1311, as an example, time elapse or switching action is monitored based on the attribute ‘Time’ mentioned above with reference to FIG. 34. That is, the display element is displayed only during the time of the value of ‘Time’. Alliteratively, in case ‘Time’ is 0, the display switching is performed in response to a user's mouse click etc.

Then, the processing is returned to the step S305. After that, the summary display is ended after the same processing is repeated (in the steps S1306 through S1312) and, consequently, all the display elements are thus processed (in a step S1313).

Thus, the expansion program 112 which has the summary display function creates the summary frame 402, when a user directs (in the step S1304), and it performs operation of starting sequentially the expansion programs 112 corresponding to the contents of the summary, and thus displays the summary.

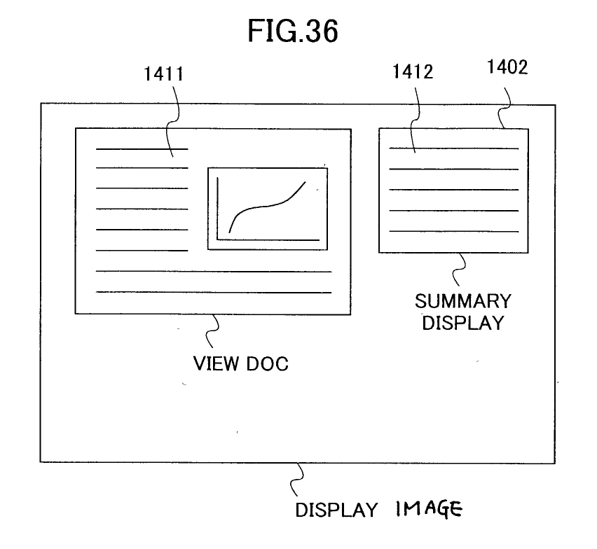

FIG. 36 is a typical view showing an example of a summary display 1412 displayed in the summary frame 1402 in the view document (or displayed document) 1410 on the display device 1310.

When summary information is displayed on the summary frame 1402, a position, size, etc. thereof may be beforehand set up as attribute values in the above-mentioned summary function tag, the summary frame 1402 may be created according thereto, or, the size of the summary frame 1402 may be changed to a suitable size automatically according to the contents of the present display.

Specifically, the size of the display image in which the summary display is displayed may be detected, and, thereby, the size of the summary frame 1402 may be determined accordingly. Furthermore, the summary frame 1402 may be placed in the center of the view document, or may be displayed throughout the display image (window). This setup may be performed based on the attribute value acquired through the attribute analysis in the step S1308 as mentioned above, and the user may be able to change it at a time of the summary display through input operation.

Moreover, in case the view document image 1410 currently displayed is obstructive for a user to view the summary display, the view document image 1410 may be made into invisible state, and, then, after the summary display is finished, the view document image 1410 may be returned to a visible state.

Various forms of the summary display performed in the step S1310 may be made on the display device 310. Specifically, text information 1411a, image information 1411b, animation information 1411c, or voice information that is not shown may be included in the view document image 1410 shown there, as the summary display.

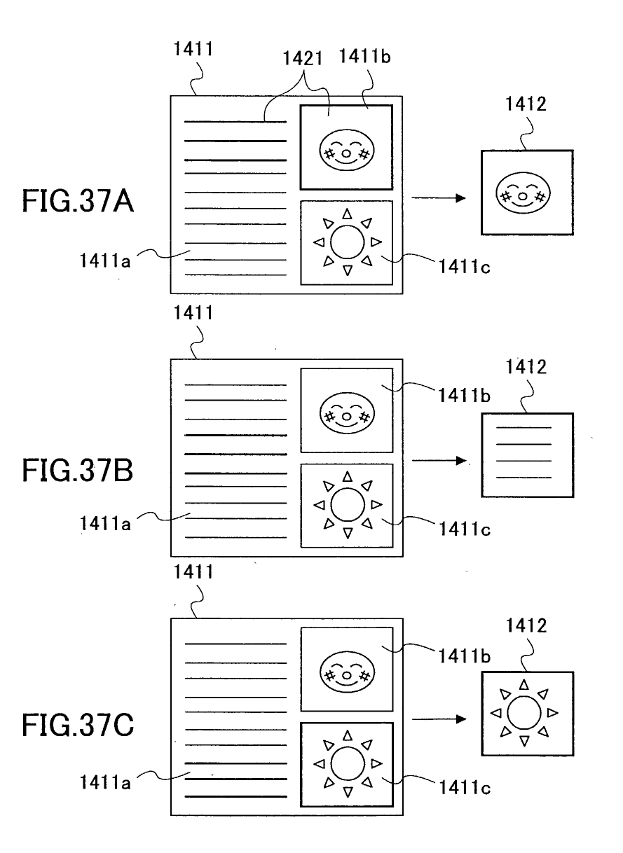

FIGS. 37A, 37B and 37C illustrate an emphasis display manner. In the flow chart of FIG. 35, processing performed for an emphasis display (in a step S1310-1) is shown, in the expansion program, relating to the information display of the step S1310. This processing is processing of displaying with emphasis of a portion 1421 in the view document 1411, for example, as shown in FIG. 37A, which portion is a portion for which the summary display is currently made. Thereby, it is possible to clearly show to a user which portion of the view document 1411 is a portion for which the summary display is currently made.

In case the summary display include voice information but the summary information is made of text information, the summary information may be read by means of a voice synthesis function mounted in the expansion program 112 according to the text information. On the other hand, in case the view document 1411 has voice file attached thereto as summary information, a voice recognition function may be mounted in the expansion program, and thereby, the voice file is transformed into text information which is then displayed as the summary display 1412. Such processing handling voice information may be such as that described above with reference to FIG. 19.

In addition, such summary providing information may be provided separately from a particular view document 1411, or may be created by appropriately extracting from the contents of the document. As an example of the processing appropriately extracting from the contents of document, only a portion of the beginning of each paragraph in the view document 1411 may be extracted, and the thus-extracted contents may be displayed in sequence as the summary.

In case an animation is included in the summary, if all the animation accompanying the relevant document were reproduced as the summary information, it would become too long in time for a user to view it. Accordingly, by a part, for example, an important part of the animation information may be extracted, to be used as the summary information. For this purpose, merely an attribute value indicating the part of the animation file to be extracted may be described in a tag for each display element beforehand, in order to reproduce only the part of the animation information as a summary.

Thus, as described above, it is possible to provide various types of summary display on the display device 310 on the occasion of summary display in the step S1310.

The tag indicating summary function is described in the document arrangement information 102, and thereby, viewing of the whole document and also presentation data for summary description can be simultaneously managed by one library file 201 by storing the expansion program 112 for summary function in the library file 201 simultaneously. Thereby, management of the document for which a presentation is needed can be made easy.

Moreover, as creation of the contents of a summary is made with reference to the document information included in the view document 1411 according to the above description, the summary description is automatically updated simultaneously in case the document information, to which the summary description is linked, is updated. For this reason, by managing only the document information, as the summary is thus managed at the same time, management of the contents of presentation can be made easy.

Furthermore, in the example mentioned above, a person who creates the document information also creates the summary contents. However, when an automatic summary creation program is prepared as the expansion program 112, it is possible to create the summary automatically based on the document information on the view document 1411. Such an automatic summary creation program creates the summary automatically based on the context derived from important words which are extracted based on word occurrence frequencies or emphasis expressions of the relevant document. As such, an automatic summary creation program itself, various similar types of application programs on the market may be utilized.

[Recording/Reproduction Function of User's Act Using Expansion Program]

A recording/reproduction function of user's act using the expansion 112 will now be described.

Although the recording/reproduction function of the encapsulated document 101 will now be described, in order to realize such a recording/reproduction function, it is not necessarily indispensable that it is of the encapsulated document 101. However, it is more useful to realize in the encapsulated document from a viewpoint of addition of a function by the expansion program 112.

In the encapsulated document 101, in order to record user's act such as user's operation, communicated information, or the like, a tag of XML <RECORDER/> may be provided for example.

When the program 105 reads the <RECORDER/>tag, a recording program which is the expansion program 112 for user operation and a communication recording function is started, and, a recorder button which is not shown is displayed in the display image of the encapsulated document 101.

The above-mentioned recording of user's act and communication means to record the state of a display, i.e., for example, in case the contents of a display of the encapsulated document 101 on the display device 310 are ‘display of page x’, data to be recorded is, ‘page=x’, for example.

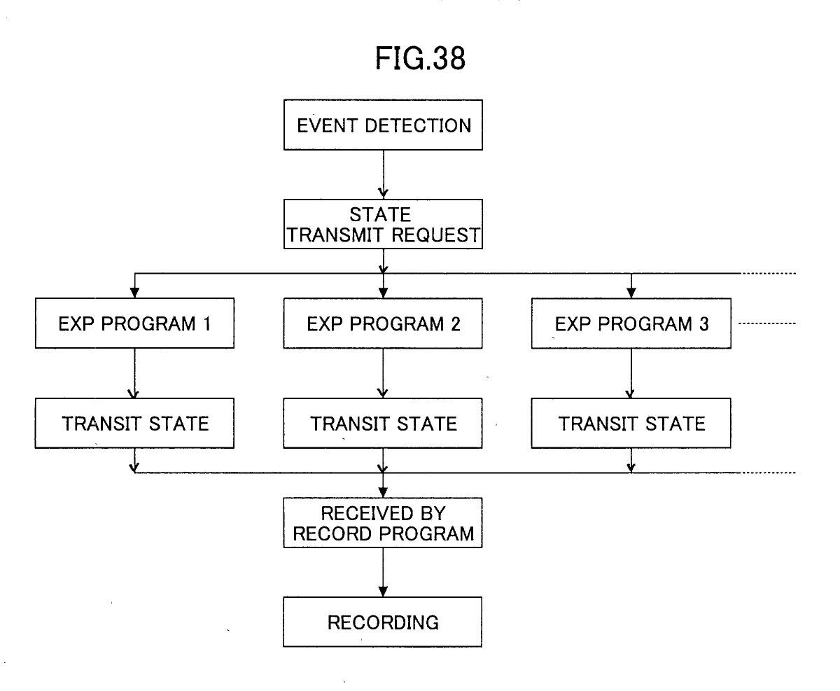

FIG. 38 is a typical view which illustrates a procedure of performing collection of document states on the document currently displayed on the display device 310. When a predetermined event, i.e., a mouse click is detected in the step 210 shown in FIG. 10, an information collection request is provided to the expansion programs 1, 2, 3, . . . , i.e., expansion program 211. The respective expansion programs 1, 2, 3 . . . then transmit state information to the recording program for recording/reproduction of user's act, i.e., the expansion program 211. Then, the recording program acquires a collection of the transmitted state information, and holds it. Communication information on communications performed between respective encapsulated documents 101 realized by the communication function, besides the above-mentioned specific operation performed by the user on the document, is also included in data to be recorded by the function of the above-mentioned recording/reproduction function.

Such recording of communication information will now be described for example. As the document state information is sent to relevant expansion programs 1, 2, 3, . . . , in case communications are performed between the respective encapsulated documents 101, these expansion pogroms 1, 2, 3, . . . send the relevant document state information to the recording program which then records this information.

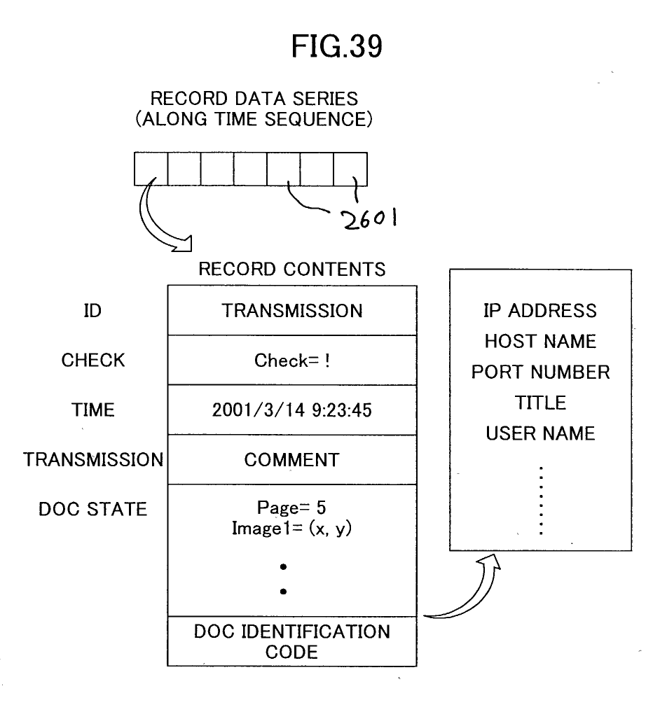

FIG. 39 is a typical view which illustrates a data structure of record data which the recording program records as mentioned above. As shown in the figure, the record data is held in a time series manner for respective predetermined record units (which record unit may be made to be able to be changed arbitrarily by a user's input operation). Each unit of the record data includes, for example, transmission ID, the time of transmission, existence/absence of a check, the document state at the time, etc., in case of information transmission. Moreover, an identification code is also recorded for the thus recorded information, i.e., identification code of the transmission source, identification code of the document on which the relevant operation is performed by a user, or the like.

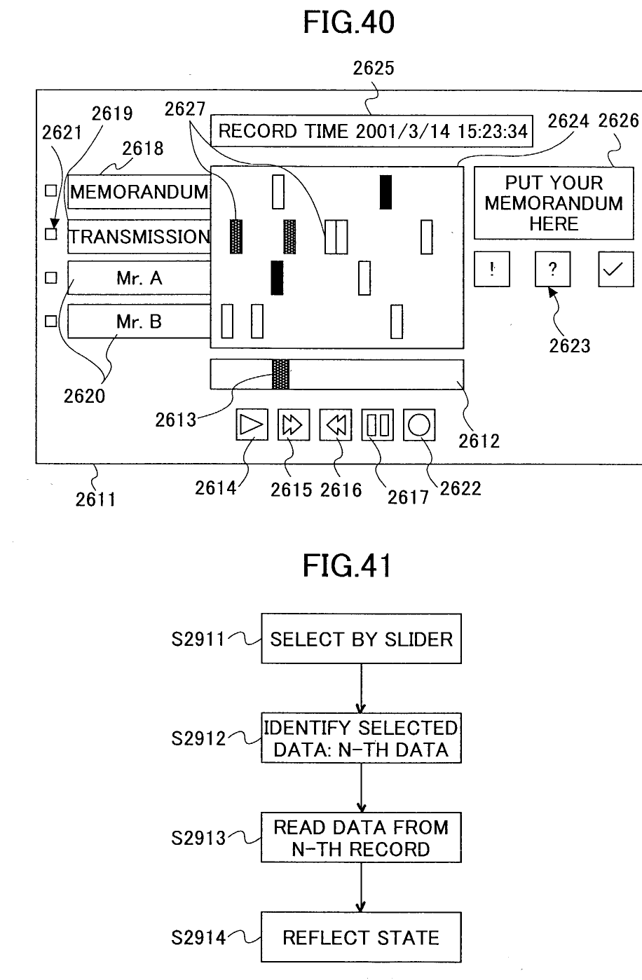

FIG. 40 is a typical view showing an example of a display provided at a time of the recording operation. When the recorder button which may be contained in the display image of encapsulated document 101 displayed on the display device 310 is clicked, the program 105 detects this action and a pop-up indication of a pop-up window 1611 shown in the figure is provided on the display device 310. In this pop-up window 1611, respective timings at which recording intentionally made by the user, transmission is made, reception is made, etc., are displayed.

Specifically, in the pop-up window 2611, a record display slider 2612, a reproduction button 2614, a fast forward button 2615, a rewind button 2616, a stop button 2617, a memorandum button 2618, a transmitting button 2619, a receiving button 2620, check boxes 2621, a record button 2622, and check buttons 2623 appear, as shown in FIG. 40.

Further, a record progress display field 2624, a time display field 2625, and a memorandum writing field 2626 are prepared on the pop-up window 2611, as shown in the figure. A record identifiers 2627 which become metaphors of records are displayed on the record progress display field 2624. These record identifiers 2627 are placed in such a manner that the memorandum button 2618, the transmitting button 2619, and the receiving button 2620 are regarded as the vertical axis, while time elapse is regarded as the horizontal axis. Thus, how respective recording operations have been made can be visibly indicated.

The record display slider 2612 is an object for calling a document state from the information saved at a time, and changing the document state to the thus-called one by moving a bar 2613 to a desired time

FIG. 41 is a flow chart which shows an operation flow of the processing which the expansion program 112 performs according to the operation of the record display slider 2612. As shown in the figure, when a record is selected by the record display slider 2612 (in a step S2911), the number of the record is determined along the time-sequence record data (in a step S2912). For example, the record data selected is N-th data shown in FIG. 41, the N-th data of the time-sequence record data is read out (in a step S2913), and, then, the relevant document state information stored in a storage area not shown in the figure is read out. Then, the contents thereof are displayed, and, also, the current display reflects the thus-obtained state information (in a step S2914).

The reproduction button 2614 is used for displaying successive changes of the document state in a time-series manner. The fast forward button 2615, rewind button 2616, and stop button 2617 are also buttons for the respective functions. The memorandum button 2618, transmitting button 2619, “Mr. A”, and “Mr. B”, and the check boxes 2621 to the left of these receiving buttons 2620 are those for choosing the data to be reproduced.

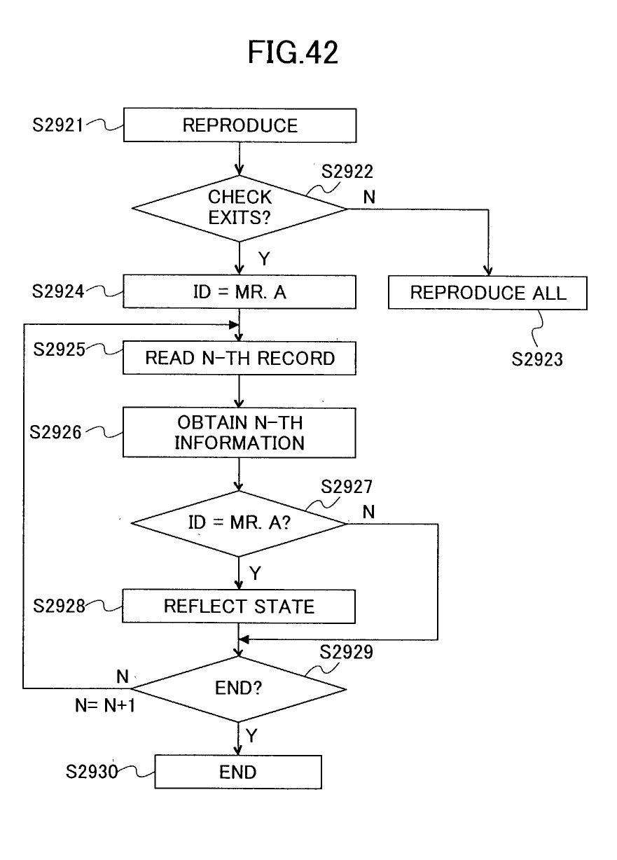

FIG. 42 is a flow chart which shows an operation flow of this reproduction processing. When the program 105 detects an action that the reproduction button 2614 is clicked (in a step S2921), it examines as to whether or not the respective check boxes 2621 have check marks put therein (in a step S2922).

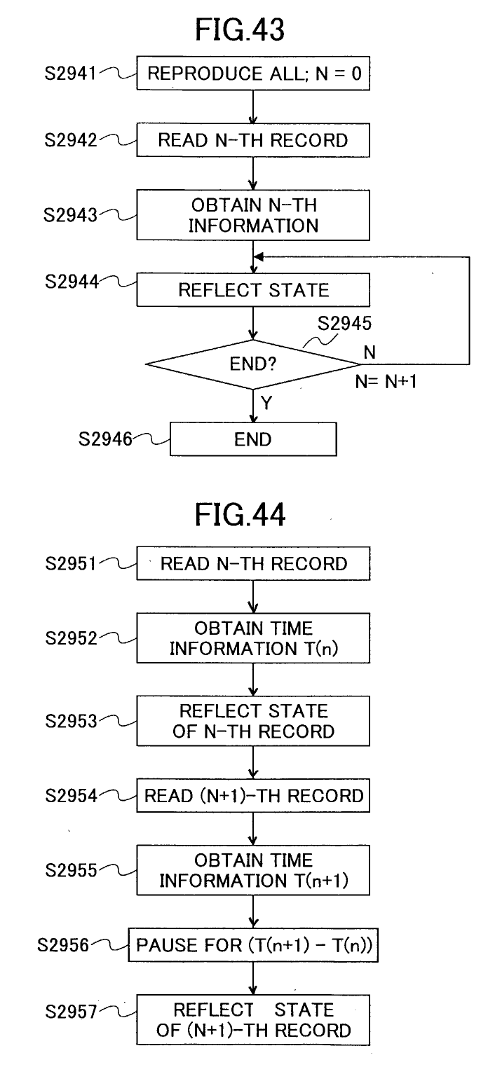

As a result, when no check marks are put therein, all the records are reproduced (in a step S2623). For this purpose, as shown in FIG. 43, reading of the records is started from the record of N=0, thus, the N-th record is read (in a step S2942), and the relevant information is obtained (S2943). Then, the document display is changed into the state based on the thus-obtained document state information, and thus, the document state information is reflected (in a step S2944). After that, it is determined that all the records have been processed (in a step S2945). When they have not been processed yet (No of the step S2945) the data number N is incremented. Then, the N-th data is read (in the step S2942), the information is acquired (in the step S2943), and based thereon, the display is updated as mentioned above (in the step S2944). Such a procedure is repeated until all the data is processed (Yes of the step S2945).

On the other hand, as a result of checking the check boxes 2621, when there are one or some check boxes 2621 having check marks, the records on these check marks are reproduced. FIG. 42 shows processing of reproduction when the check mark is put for the record received from “Mr. A”, for example. That is, since there is the check on the reception record of the transmission from “Mr. A” detected as a result of checking the check box 2621, only the record of ‘ID=Mr. A’ is reflected on the display (in a step S2924). For this purpose, all the records are read in sequence starting from the record of N=0, the N-th record is read (in a step S2926), and the ID information in the read-data is examined (in a step S2927).

With reference to the data structure of the record data shown in FIG. 39, each record contains ‘ID’. This ID shows information as to a type of this record. For example, in case the record is that concerning the fact that transmission was made by own, ‘ID transmission’. In case where the record is that concerning the fact that information from Mr. A was received, ‘ID=Mr. A’.

Then, returning to the flow chart of FIG. 42, ID in the record data is examined, and, when it is ‘ID=Mr. A’, (Yes of a step S2927), the state of this record is reflected on the current display (in a step S2928). On the other hand, when ID is not ‘Mr. A’, it is determined whether the relevant data is the last one (in a step S2929). Then, when it is the last data, the current processing is finished (in a step S2930). However, when it is not the last (No of the step S2929), the following data is read as N=N+1 (in a step S2925). Thus, only the record having ID=Mr. A is reproduced by repeating the above-mentioned procedure until the data finishes.

The record button 2622 is used when a user wants to save record of a document state intentionally.

The check buttons 2623 is used for attaching information, such as “important (!)”, “question (?)”, to the record of document state. When such information is attached by means of these check buttons 2623, according to the information attached, the color of the corresponding record identifier 2627 displayed in the record progress display field 2624 may be changed appropriately.

In this connection, it is possible that, the check buttons 2623 are displayed together with the record button 2622, and, thereby, when the check button 2623 of “important” is clicked, for example, this matter is recorded in the record, as ‘Check=important (!)’ as shown in FIG. 39, as the document state.

The contents written to the memorandum writing field 2626 are recorded together with the record data. The record data in this case is record data displayed at the time the comments are thus input.

Moreover, at a time of recording, time information is acquired from a personal computer 301, and the thus-acquired record time is stored with the record of document state. Moreover, the time of document starting may be also stored, and a time measured therefrom may also be stored Such time information is displayed on the time display field 2625.

FIG. 44 is a flow chart which shows this time setting processing. Control of a time interval in each of cases of processing of reproduction mentioned above, fast reproduction, reverse reproduction, and pause is performed based on the current time obtained from the personal computer.301. That is, when changing reproduction to the (n+1)-th record from the n-th record as shown in FIG. 44, for example, the n-th record is read (in a step S2951), and the time information T(n) is acquired therefrom (in a step S2952). Then, the (n+1)th data is read (in a step S2954) after reflecting on the display by the contents of the first read record is performed (in a step S2953). Thereby, the time information T(n+1) is acquired from the (n+1)-th record (Step S2955). Therewith, the time lag from the n-th record is calculated, and then, reflection of the (n+1)th record data onto the display is delayed by the calculated time lag (in a step S2956). In case of fast reproduction, this delay time is made into a half, for example.

It is also possible that, each time a record is taken, the time difference data is stored as a part of the record data, and, thereby, at a time of reproduction, the thus-stored data is utilized. Thereby, it becomes not necessary to calculate time difference each time of reproducing.

Since the above-mentioned record is created for each encapsulated document 101, each encapsulated document 101 has unique communication record and operation record.

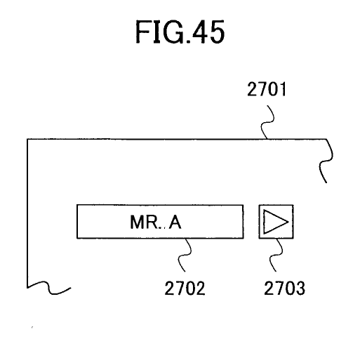

FIG. 45 is a typical view which illustrates a search word input panel. Without preparing the pop-up window 2611 shown in FIG. 39, or within such a pop-up window 2611, the search word input panel 2701 shown in FIG. 45 may be displayed. Such a search word input panel 2701 includes a search word input field 2702 and a reproduction button 2703, The search word input field 2701 is used for inputting, for example, a name of a person for whom the contents of record is to be reproduced. Then, after the inputting, the reproduction button 2703 is pressed. When the reproduction button 2703 is pressed, the relevant user name in the document identification code in the record data is searched for, the thus-obtained record corresponding to the corresponding user name is read out, and processing of performing reflection thereof onto the document state is performed. In this case, other than the user name, any information by which a specific record can be identified may be used instead, such as IP address, host name, or the like.

Moreover, it is also possible to reproduce only the record on which a check mark of “important (!)” is put into the check boxes 2621 shown in FIG. 40, by using a search word input panel 2701 shown in FIG. 45. In this case, “important” should be input into the search word input field 2702.

Moreover, as record of the time is also taken, it is also possible to search for the document state at a time by inputting into the search word input field 2702 the time of record or a time elapse from the document start.

Moreover, as a function that comments can be attached to the record (memorandum writing field 2626 shown FIG. 40), it is also possible to search for the record by specifying a word included in the comments.

Furthermore, ‘reverse search’ is also possible in which, by using a document state itself as a keyword, such as “15 pages”, for example, the relevant record is searched for, and, then, the comments put thereon are obtained, for example.

Although recording a document state has been described, when an encapsulated document 101 according to the embodiment of the present invention is used for a meeting, etc., it is possible to take a record of not only the encapsulated document 101 but an utterance (sound). In this case, by providing a connection between a record of the document state and a record of the utterance, it becomes possible to take a detail record of the meeting. When such a record is taken, by applying well-known speech recognition technology and well-known voice synthesis technology, it also become easier to search the document state relevant to the utterance by searching for the utterance, or to hear the utterance at a time from the record having a certain document state, conversely. Moreover, when an image at a meeting is picked up on a videotape, it is possible to take a record of the meeting together with the image as long as the document state.

When the technology of recording a user's act as in the embodiment of the present invention is used in combination with a meeting record system for recording an image and a sound at a meeting, it is remarkably advantageous. Instead of such a form of combination, it is possible to add a software program concerning voice recording and image videotape recording as the program 105 of the encapsulated document 101.

[Client/Server System]

According to the embodiment of the present invention, the personal computer 301 as an information processing apparatus may be connected with a server 3401, another personal computer, through the network, and, thus, they may form a client/server information processing system. In such a client/server system, the personal computer 301 plays a role of a client.

Such a client/server system may perform various types of processing in unique to this system. Such processing will now be described.

(1) Download of the Operation Program File from the Server to the Client:

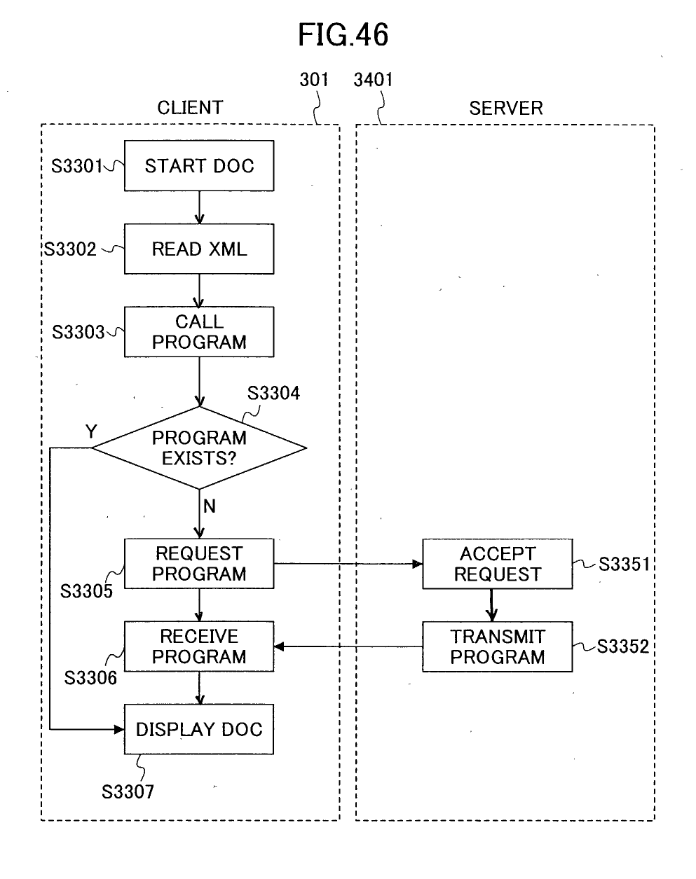

FIG. 46 is a flow chart which shows an operation flow of processing in case a required operation program file does not exist in the encapsulated document 101.

At a time of starting of the encapsulated document 101 in the personal computer 301 as the client (in a step S3301), XML is read (in a step S3302) and thus the program 105 which is an operation program file is started for every tag (in a step S3303).

In this case, it is determined whether a program 105 required for displaying on the display device text information 103 and the media information 104 as digital information files included in the encapsulated document 101 exists in the encapsulated document 101 (in a step S3304). The basic program 111 in the program 105 performs this determination processing. Consequently, in case there is no such a required program 105 in the encapsulated document 101 (No of the step S3304), the basic program 111 issues a transmission request for such a program 105 to the server 3401 (in a step S3305).

The server 3401 receives such a program transmission request (in a step S3351), and the thus-required program is transmitted therefrom to the personal computer 301 which is the client (in a step s3352).

The personal computer 301 which is the client receives the program 105 (in a step S3306), starts the received program 105, and displays the document by means thereof (in a step S3307).

(2) Document View Permission

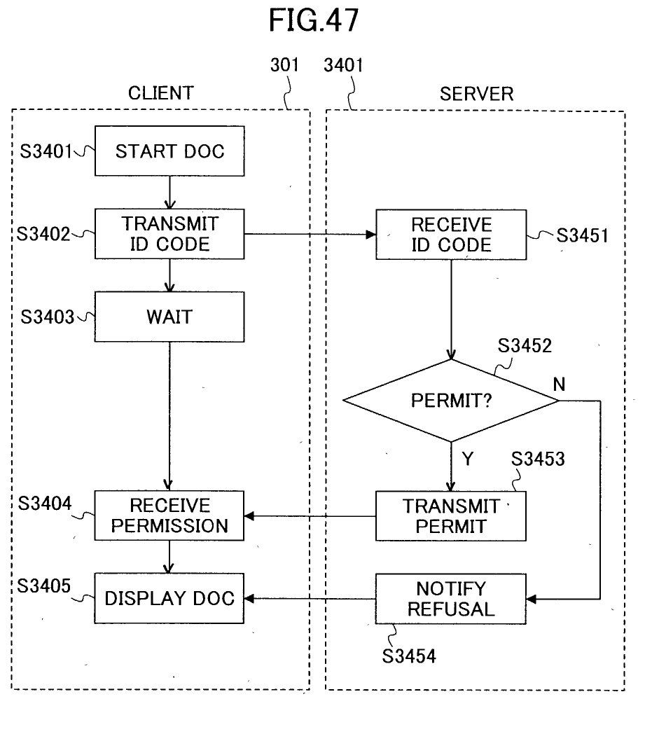

FIG. 47 is a flow chart which shows an operation flow of processing of document view permission with the server which receives the program transmission request.

When an encapsulated document 101 is started in the personal computer 301 which is the client (in a step S3401), an identification code which the document is transmitted to the server 3401 (in a step S3402). Then, the personal computer 301 waits for permission (in a step S3403).

Then, the server 3401 receives the identification code (in a step S2451), refers to a permission list held beforehand, and, based on information such as the user's name, title, version or the like included in the identification code with respect to the permission list, determines whether permission for the document view can be given to the personal computer 301 (in a step S3452). When permission is given as a result of the above-mentioned determination (Yes of in the step S3452), a permission is transmitted to the personal computer 301 (in a step S3453). Otherwise, a refusal notice is given to the personal computer 301 if permission is not given (No of in the step S3452, and in a step S3454).

In the personal computer 301 which is the client, only when the permission is received (in a step S3404), the document display is achieved (in a step S3405).

In the encapsulated document 101, a software program 105 which has various functions is stored as well as various contents. Therefore, fine-tuned management, i.e., display of certain contents are not permitted, certain functions are not permitted, or the like, for particular types of users, may be provided, as a result of identification codes being given for respective contents and programs, and permission being given for respective contents and program.

(3) Receipt of File for Meeting Participation

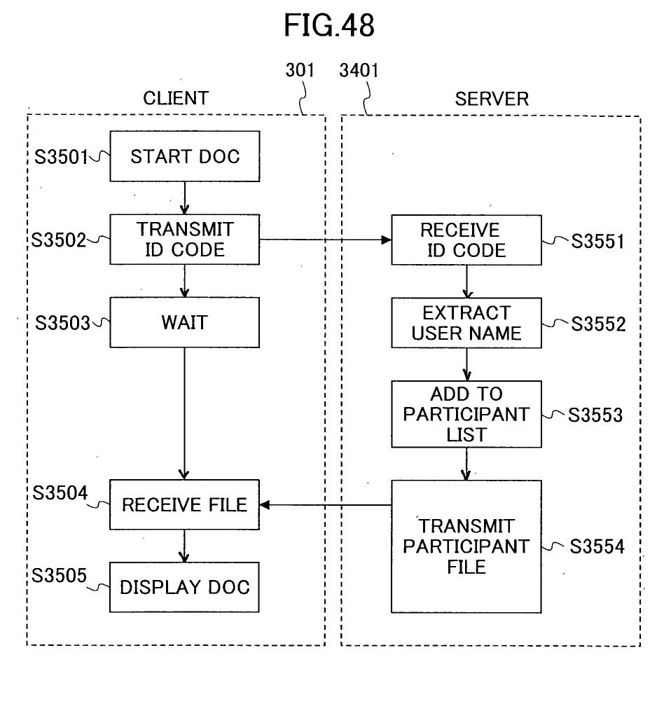

FIG. 48 is a flow chart which shows an operation flow of receipt processing for a file for displaying meeting participants.

When a document 101 is started by the personal computer 301 which is the client (in a step S3501), the identification code which the document has is transmitted to the server 3401 (in a step S3502). Then, the personal computer 301 waits for reception (in a step S3503).

In the server 3401, the transmitted identification code is received (in a step S3551), the user's name is extracted from the received identification code (in a step S3552), the server 3401 adds this user's name into a meeting participant list which the server 3401 holds (in a step S3553). Then, the server sends a digital information file showing each participant, including, for example, a face image, an animation, etc. is transmitted to all clients including the above-mentioned personal computer 301 (in a step S3554).

In all the clients including the personal computer 301, the digital information file related to the participants' identification codes thus transmitted is received (in a step S3504), the digital information file is used for displaying the relevant participants in a meeting participant display on the encapsulated document 101 started in the own apparatus (in a step S3505).

In the personal computer 301 (client), in case the identification code is transmitted to the server 3401, it may also transmit image data which the user wishes a display thereof to the meeting participants. In that case, the server 3401 registers this image data as a new digital information file (in a step S3553), and send it to the meeting participants (in a step S3554).

(4) Renewal of Digital Information File (Text Information 103, Media Information 104) or Program 105

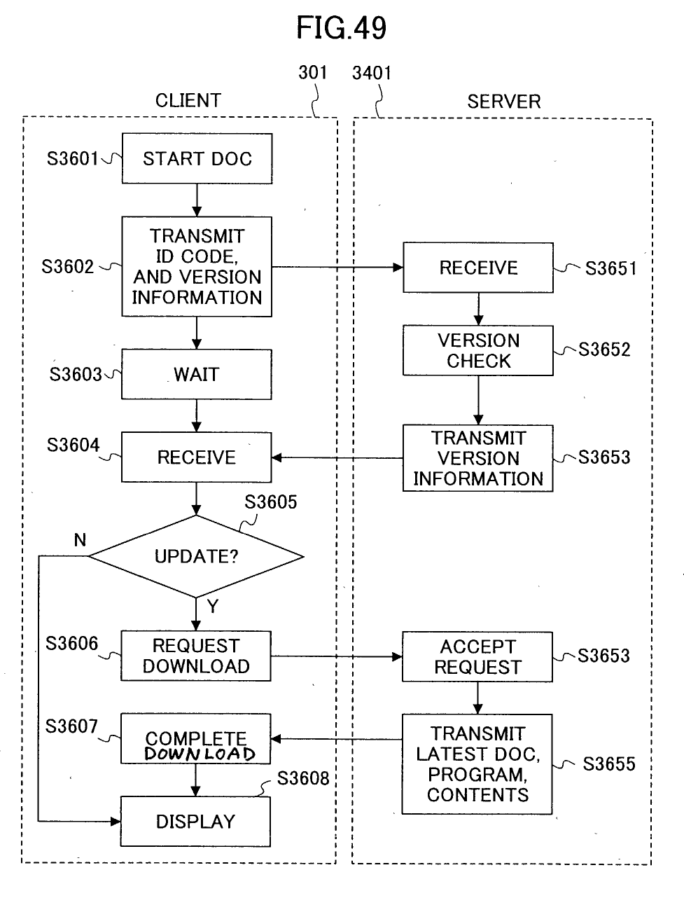

FIG. 49 is a flow chart which shows an operation flow of updating processing on a digital information file or an operation program file.

At a time of starting a document 101, the personal computer 301 transmits to the server 3401 various types information, i.e., the identification code of the document, version of each operation program files as the program 105, the version of each set of contents as the text information 103 and/or media information 104, and so forth (in a step S3602), and enters a waiting state (in a step S3603).

It is assumed that the server 3401 beforehand registers these types of information, i.e., version information, and so forth, at the latest versions. Then, when such various types of information is received (in a step S3651), the server 3401 compares the received various types of information with the latest versions registered there, performs a version check (in a step S3652). Then, when it is determined the received various types of information is not of the latest versions, this matter is informed of to the personal computer 301 which is the client (in a step S3653).

In the personal computer 301, this information is received from the server 3401 (in a step S3604), and the user is asked for updating determination for the information which is not of the latest version based on the thus-received information (in a step S3605). Then, in response to an operation by the user given to the personal computer 301, the personal computer 301 maintains the current display when the user does not determine to update the relevant information (No of in the step S3605). On the other hand, when the user determines to update the information (Yes in the step S3605), the personal computer 301 sends a download request to the server 3401 (in a step S3606).

When the server 3401 receives the download request (in a step S3654), it transmits the latest version of relevant information to the personal computer 301 (in a step S3655).

The personal computer 301 completes the download (in a step S3607), and, then, it displays the document of the downloaded latest version (in a step S3608).

As the information to be downloaded there from the server 3410 may be any types of information, i.e., digital information files (text information 103, and/or media information 104) as the contents, program 105 for displaying them, and so forth.

(5) Download to Client of Mass contents Server Holds

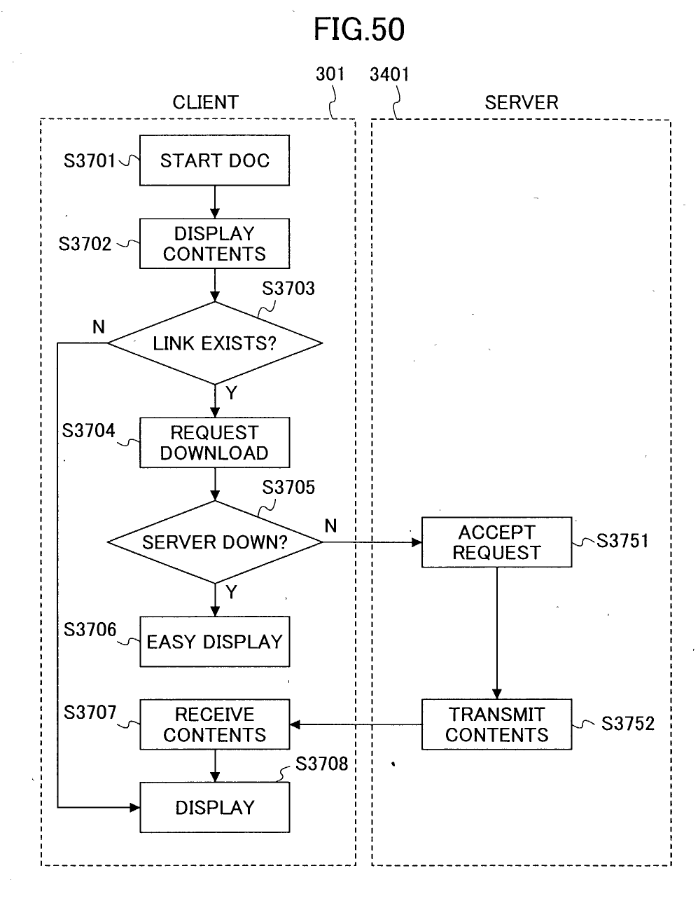

FIG. 50 is a flow chart which shows an operation flow of download processing to the client of mass contents which the server holds.

The personal computer 301 which is a client starts an encapsulated document 101 (in a step S3701), and displays the contents (text information 103-and/or media information 104) thereof (in a step S3702). Then, it examines as to whether any link information on the contents exists(in a step S3703).

When the contents started do not includes any link information (No of the step S3703), the current display is continued (in a step S3708). However, a download request is sent out therefrom when the contents started include link information (Yes of in the step S3703) to the server 3401 (in a step S3704).

In that case, the personal computer 301 displays a digital information file prepared beforehand such as an image when it determines that the server has gone down (Yes in a step S3705). On the other hand, when it is determined that the relevant contents can be downloaded from the server 3401 (No of in the step S3705), the download request is accepted by the server 3401 (in a step S3751), and the server 3401 transmits the contents towards the personal computer 301 (in a step S3752).

The contents are displayed by the personal computer 301 when the personal computer 301 receives the contents from the server 3401 (in steps S3707 and S3708).

The personal computer 301 may provide an easy display during the downloading operation, with a digital information files, such as image data. (6) Update of Version Information of Digital Information File (Text Information 103, Media Information 104) or Program 105

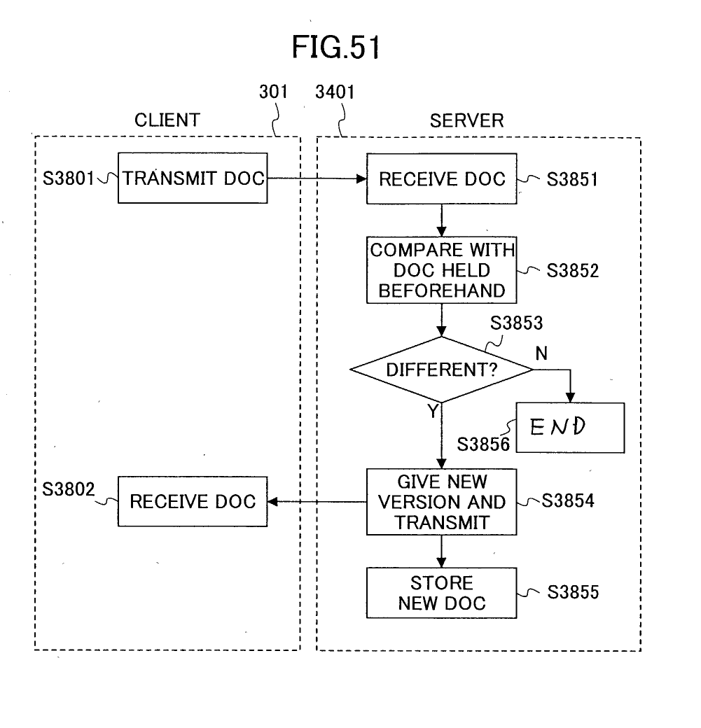

FIG. 51 is a flow chart which shows an operation flow of updating processing for version information on a digital information file or an operation program file.

An encapsulated document 101 is transmitted to the server 3401 from the personal computer 301 which is a client (in a step S3801).

The server 3401 receives the encapsulated document 101 (in a step S3851), and compares it with a corresponding document currently held beforehand (in a step S3852). Consequently, when there is a different portion therebetween (Yes in the step S38523), the version information included in the identification code of the encapsulated document 101 sent from the client is updated, and the document is returned to the personal computer 301 (in a step S3854). Simultaneously, the server 3401 takes a copy of the document of the new version, and save it as the corresponding encapsulated document 101 of the new version (in a step S3855). When no difference is found out between the received document and the corresponding document currently held beforehand as a result of comparison examination in the step S3853 (No in the step S3853), the processing is ended (in a step S3856).

The personal computer 301 receives from the server 3401 the encapsulated document 101 having the version information included in the identification code updated (in a step S3802).

[Encapsulated Document Creation Service]

As described above, it is possible to display digital information files (text information 103, media information 104) of various types by the display device, or to add various functions to the document by the expansion programs 112, according to the encapsulated document 101 in the embodiment of the present invention. Further, as a new function is added to the encapsulated document 101, it may be possible for a viewer to easily understand the contents of the document. However, such an operation of adding a new function may be troublesome for a user.

A first reason therefor is that it is necessary to master how to edit the document in order to produce the encapsulated document 101 which has a new document form.

A second one is that it is necessary for the user to perform a special operation for adding a new function to the encapsulated document 101, and, also, it may be necessary to collect necessary information for the same purpose. In order to effectively reduce such troublesomeness, according to the embodiment of the present invention, a user may be provided with a service which will now be described, by using a digital-communication network, such as the Internet. In this connection, the system may collect the costs (consideration) from the user corresponding to this service.

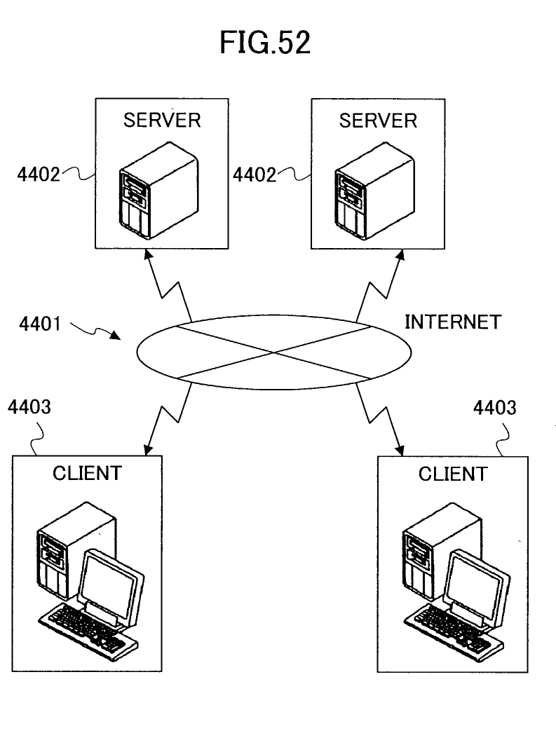

FIG. 52 is a typical view of a client/server system built using the Internet. This system includes servers 4402 as a plurality o service apparatuses which perform information provision, management, etc. through the Internet 401, as shown in FIG. 52, and clients 4403 as a plurality of user apparatuses which receive such information provided by the servers 4402 or newly provide information. Usually, each client 4403 is made of a personal computer 301 mentioned above, and each server 4402 is also made of a computer but having a larger capacity and a higher efficient throughput. That is, by using the Internet 4401, the personal computer 301 used as the client 4403 can request information provision from the server 4402 in a scattering manner, or can transmit unique information so as to request information processing thereon. (1) Device for Reducing Troublesome Due to First Reason

As a device for saving the time and effort of creation of a new document form concerning the above-mentioned first reason, service using the Internet 4401 will now be described with reference to FIGS. 52, 53, 54 and 55.

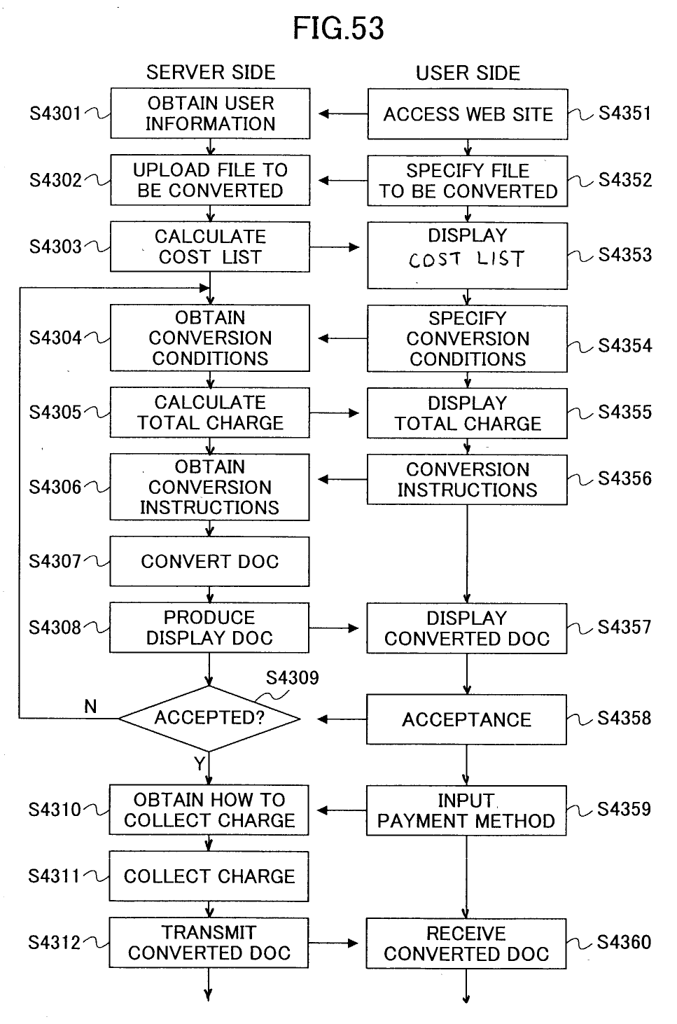

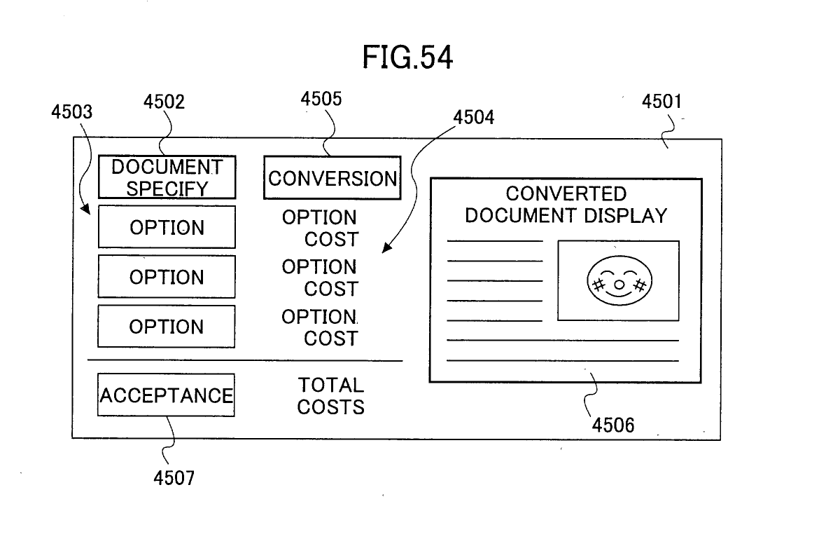

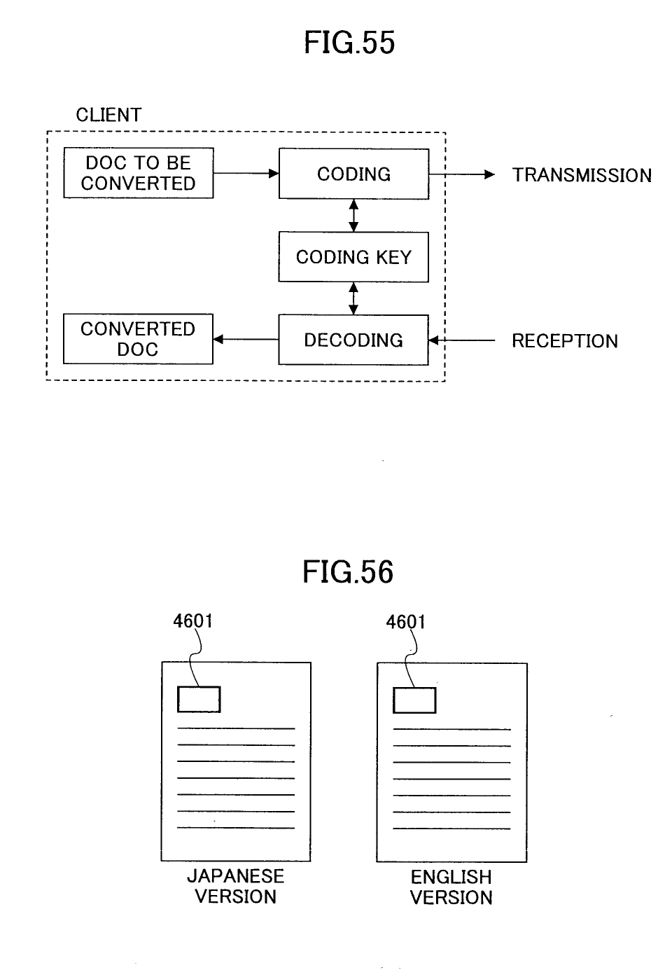

FIG. 53 is a flow chart illustrating operation of the server 4402 and client 4403 connected by the Internet 4401; FIG. 54 shows a typical view of a conversion service image provided by the server 4402 to the client 4403 for providing document conversion service; and FIG. 55 illustrates a security protection method performed on the network in this regard.

A user creates a document with a document form familiar to the user. Next, as shown in FIG. 53, a web site which provides a document conversion service is accessed through the Internet 4401 by the user (in a step S4351).

Then, the server 4402 which provides the web site on the Internet providing such a document conversion service acquires the relevant user's information (in a step S4301). As the acquisition technique for the user information in this case, such user information is registered beforehand, and a membership system having a login attestation system may be utilized, or the user information saved on the PC may be directly obtained therefrom.

The server 4402 which thus acquired the user information transmits HTML data for displaying the conversion service image 4501 for conversion service as shown in FIG. 54 on the personal computer 301 of the user corresponding to the client 4403 as an HTML document.

Next, the user specifies the file which the user wishes to convert into a predetermined document form by using a document appointment field 4502 in the conversion service image 4501 shown in FIG. 54 (in a step S4352). The file to be specified there may be a document present on the personal computer 301 of the user as the client 4403 or the same present on a web page having a URL According thereto, the user 4403 uploads the specified document to the server 4402 (in a step S4302). In case an image of the document etc. is not actually held by the document itself but is to be downloaded by reference thereto, the link thereto is followed and thus, the file currently referred to is also uploaded to the server 4402. Then, the server 4402 calculates a conversion operation charge based on the thus uploaded number of files, types, data capacities, etc. thereof, and transmits the thus-obtained conversion operation charge list to the personal computer 301 on the user's side (a step S4303). Thereby, the conversion operation charge list is displayed on the personal computer 301 on the side of user (in a step S4353).

Next, a setup of various types of additional options is possible for the user by clicking additional option buttons 4503 in the conversion service image 4501. That is, the user can choose a new function to be added by clicking of the additional option button 4503 (in a step S4354).

Then, the server 4402 acquires the conversion operation conditions thus transmitted by the user (in a step S4304), and calculates expense required for the relevant document conversion operation in consideration of the conversion information/conditions (in a step S4305). Then, on the personal computer 301 on the side of user, the total amount of money is displayed on a charge display area 4504 in the conversion service image 4501 shown in FIG. 54 as a result of the thus-calculated sum total charge being transmitted to the user side computer 301 (in a step S4355). When thus-obtained such conversion conditions including the cost are acceptable by the user, user presses a conversion-start button 5505 shown in the conversion service image 5501 shown in FIG. 54, and thus, sends the conversion request to the server 4402 (in a step S4356).

Thus, the server 4402 acquires the conversion instructions (in a step S4306), and converts into an encapsulated document 101 the document which the user created and transmitted as mentioned above (in a step S4307). Then, the encapsulated document 101 after conversion thus obtained is returned to the user's personal computer 301, and is displayed thereon (in a step S4308).

After the user's personal computer 301 receives this encapsulated document 101, it displays an image thereof on a conversion document display area 4506 in the conversion service image 4501 shown in FIG. 54 currently displayed on this personal computer 301 (in a step S4357). Then, when the user see the encapsulated document 101 thus displayed on the conversion service image 4506 and the user determines acceptance thereof, the user clicks an acceptance button 4507 in the conversion service image 4501 (in a step S4358).

On the other hand, when the user cannot accept the thus-provided document conversion result, the user sends non-acceptance information to the server 4402. For this purpose, a non-acceptance button may be additionally provided on the conversion service image 4501, or a function may be provided on the acceptance button such as to cause a non-acceptance button to be displayed to be clicked by the user.

In case the user cannot accept the document conversion, the server 4402 determines this matter in the step S4309, the processing is returned to the conversion condition acquiring processing starting from the step S4304. Then, the user causes the conversion processing to be repeated by appropriately altering the conversion conditions in the step S4354. Thereby, the conversion processing is repeated until the user can accept the conversion result.

When the converted document is accepted (Yes of the step S4309), the server 4402 displays an image causing the user to input a matter as to how to pay the conversion operation charge (selection from alternatives) on the personal computer 301 on the side of user, and urges the user to input the selection result (in a step S4359). Thereby, the user chooses one method of payment, and the server 4402 acquires this information (in a step S4310). Then, when there is no problem on the payment method, the server 4401 collects the expense according to this method (in a step S4311). For the purpose of performing this in an on-line manner, a credit card, an on-line banking, etc. can usually be utilized.

Thus, the server 4402 transmits the formal document converted to the user when the expense can be collected (in a step S4312), and the user receives it (in a step S4360).

By using the above-described service, a user can create a document in a document form familiar to the user first by himself or herself, and can convert it into a document form of the encapsulated document 101 by using the service. Thereby, the user can become free from a troublesome work by paying an expense for creating the encapsulated document 101.

In the example described based on the flow chart of FIG. 53, for conversion service concerning the encapsulated document 101, a user is charged. However, in order to spread a new document form of the encapsulated document 101, conversion. service without charge may also be considered as another example of the system.

On the other hand, when charging a user to conversion service for the encapsulated document 101, a document to be displayed to the user for the purpose of visual check and to be transmitted to the user's personal computer 301 for this purpose in the step S4308 in FIG. 53 may not necessarily to be the completely converted document but may be one obtained through a conversion processing in such a simplified manner as that for the user's check purpose only. This is because if the completely converted document were sent to a user, it might be obtained by the user falsely without payment by the user.

Accordingly, actually, the encapsulated document 101 actually converted is not transmitted but the converted encapsulated document 101 is executed virtually on the server 4401, and only image data thereof is sent to the user. Thus, it is possible to allow the user to perform the conversion check by sending merely the image data not sending the actually converted document. In this case, when some types of operations included in the encapsulated document 101 are performed by the user for the purpose of modification of the like on the thus-sent image data, only an image which should be obtained after these operations is sent to the user.

Alternatively, the encapsulated document 101 after the conversion may be sent to the user as a converted document encoded by a special code, and when there is no code information from the server 4402 currently accessed, the user cannot actually operate the document. That is, the document sent to the user in this case is such a type of document that it can be operated only while the user's personal computer 301 accesses the relevant server 4402, and, after the access is finished, it cannot be actually operated. Then, the encapsulated document 101 can be operated by the personal computer 301 on the side of a user only after the acceptance in the step S4358 in FIG. 53 is achieved, and, then, the formal encapsulated document 101 or the above-mentioned special code is sent to the user's personal computer 301.

FIG. 55 shows a typical view which illustrates a security protection technique on the network according to the embodiment of the present invention. A user may wish to put a security on a document 101 on the occasion of transmission and reception of the document with a web page which manages the above-mentioned document conversion service. In this case, as shown in FIG. 55, after encoding the text information, image information, etc. of the document to be converted using a suitable code key by the client 4403, the thus-obtained information is transmitted to the server 4402, and after the server 402 decodes the document received using the code key, it is converted into the encapsulated document 101. In this case, since the relevant document conversion according to the embodiment of the present invention can be correctly carried out as long as the length of arrangement information or text, the size of image, etc. are known, the substantial information of text and/or the contents of image are not necessary for the propose of document conversion actually.

Accordingly, as another method, without performing such encoding etc. but only a document structure, such as the length of text, arrangement, and/or arrangement of image are sent to the server without sending the substantial contents of the actual document.

Furthermore, although the example described above provides conversion of document form (of the encapsulated document 101), it is also possible to provide a service by which the encapsulated document 101 is transmitted from a user, and a new function is added to this encapsulated document 101. Furthermore, it is also possible to provide a service by which, the encapsulated document 101 is transmitted from a user, and, it is converted into another common document form. (2) Device for Reducing Troublesome Due to Second Reason

A device for coping with that the above-mentioned necessity of the work to be made for the purpose of adding a new function to the encapsulated document 101, or collection of information required for such a function adding processing will now be described with reference to FIG. 52, 56 through 59.

1) Automatic Translation

The encapsulated document 101 may have various types of functions. For example, when a plurality of types of digital information is provided on a same area as a function of the above-mentioned expansion program 112, it is assumed that a function is provided such that a display is made in a switching manner between these types of digital information. And also, it is assumed that, on the above-mentioned document arrangement information 102, a description is made for arranging a button for calling a relevant expansion program 112 for performing this switching display.

By such an expansion program 112, it is assumed that information on two languages, i.e. Japanese and English can be changed-over by a display change button 4601, as shown in FIG. 56. In this case, by clicking the display change button 4601, the Japanese display and English display are changed-over simply and these two documents can be managed as one document.

However, creating document information in such plurality of languages may be troublesome. Then, the document conversion service described above based on FIGS. 52 through 55 may further have a function such that, the server 4402 performs automatic translation using an automatic translation function in common technology on text information of the document, and thus, changes it into the corresponding document to which text of the specified language is added. Thereby, a person who provides such a document can become free from a troublesome of translation by using such document conversion service in the embodiment of the present invention.

Such a service adds new translation information to the document itself. Accordingly, compared with a mere translation service, it becomes possible to save time since a creator should not perform an extra operation of attaching translation information to the original document.

Moreover, since the thus-obtained document can be displayed in a switching manner between different languages by easy operation, a viewer can determine how to treat the relevant document rapidly.

Furthermore, in the above-mentioned document conversion service, when an operation needed for a layout of text document, image, etc. is performed together with the other operations described above to be included in the document conversion service, it is possible to further reduce a troublesomeness in the creator.

2) Annotation

As a subsequent function, an example of an annotation function which displays meaning of a technical term in on document displayed may be given.

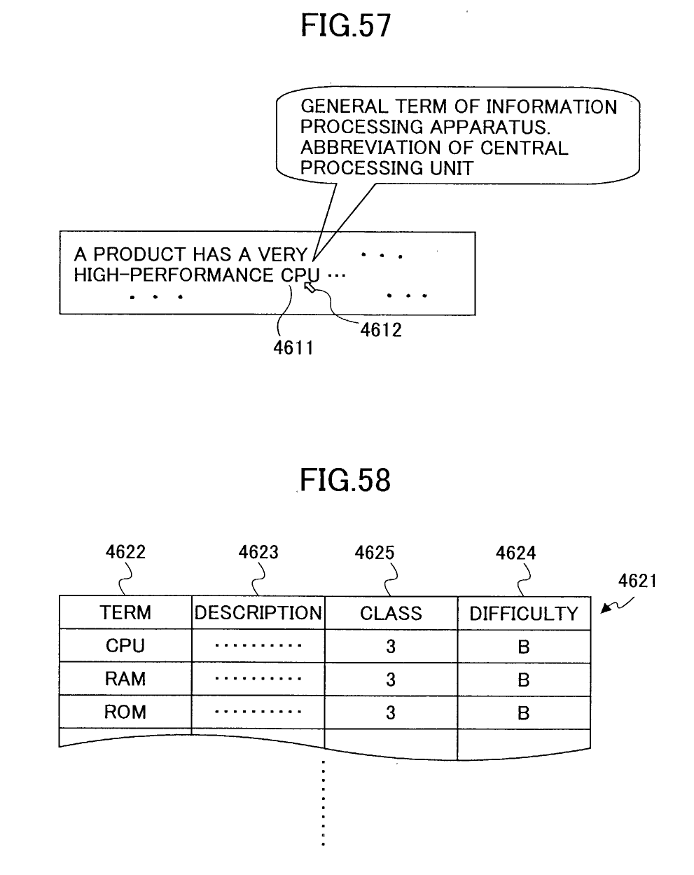

Specifically, as shown in FIG. 57, when a cursor 4612 is placed-onto a technical term 4611 in a document displayed, according to the annotation function, the meaning of the technical term 4611 is additionally displayed by the function of an expansion program 112 will now be described.

The encapsulated document 101 which has such a function holds a data file 4621 for meaning corresponding to each technical term 4611 and the respective technical terms 4611 as shown in FIG. 58. As the function of the expansion program 112 for displaying such text information, when the cursor 4612 is positioned on the technical term 4611 on the text information displayed, this event is detected at in the step S210 in the flow chart shown in FIG. 10 (Yes of the step S210). The word (technical term 4611) of the text corresponding to the coordinate position at which the cursor 612 is placed is extracted from the data file 4621 for meaning, the meaning data (description 4623 in FIG. 58) corresponding to the extracted word (term 4622 in FIG. 58) is thus searched for, and it is displayed on the display device 310. Thus, when the encapsulated document 101 is used, the function which displays the meaning of the technical term 4611 can be easily added.

However, it may also be troublesome for a person who provides a document to additionally provide such information including the meaning of each of such a technical term 4611. Then, in order to reduce such troublesomeness in a creator, the service may provide a function of adding the meaning of each technical term 4611 to the document in the document conversion service described above based on FIGS. 52 through 55.

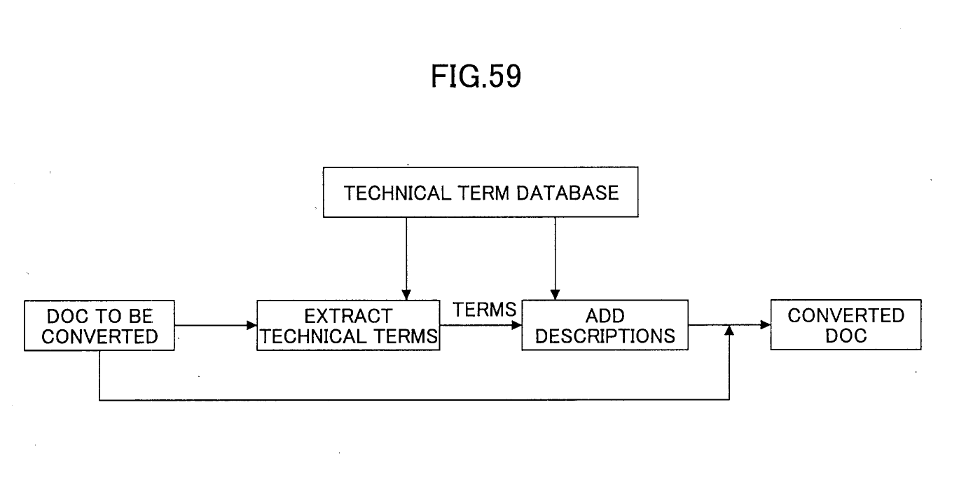

For this purpose, it is necessary merely to perform operation as shown in FIG. 59 at a time of the document conversion in the step S4307 of the flow chart of FIG. 53.

First, by utilizing a technical term database, which may be one of those widely put into the market, terms same as those existing in a received document are extracted, and, then, annotations corresponding thereto are extracted from the above-mentioned technical database. The data file 4621 for meaning which consists of pairs of the term 4622 each of which includes the technical term 4611 and its description 4623 can thus be created. Then, the encapsulated document 101 with this term annotation function can be created by adding to the document before the conversion this data file 4621 for meaning.

It is also possible to additionally provide an expansion program 112 especially for this term annotation function to the document.

There may be many technical terms 4611 having the same spelling but having different meanings. Such a case may occur especially when the relevant terms are abbreviations. For example, a term ‘EC’ has a meaning of European Committee and a meaning of Electronic Commerce. In order to properly select from such terms having same spelling, a classification 4625 for specifying the field of terms 4622 may be added to the data file 4621 for meaning, as shown in FIG. 58. Then, in case a document creator has such a term annotation service, the creator may be made to choose a specific technical field. Alternatively, such a specific technical field may be automatically estimated from the terms extracted from the received document as mentioned above, and, in case there are a plurality of meanings for single word, a description which is determined to be most relevant to the thus-estimated technical field may be displayed as the annotation.

3) Adding Summary

As another function of the above-mentioned document conversion service, it is possible to add a summary of a document into the encapsulated document 101, as described above with reference to FIGS. 33 through 37C.

Although a document creator may also actually create a summary thereof, when the summary of the document is an easy summary, it can be automatically created by a computer now using well-known various languages processing technology.

Then, it is possible to add, to the document conversion service, a function of such summary creation.

Further, the present invention is not limited to the above-described embodiment, and variations and modifications may be made without departing from the scope of the present invention.

The present application is based on priority applications Nos. 2001-198818, 2001-287273, 2001-287275, 2001-288515, 2001-289781 and 2001-290175, filed on Jun. 29, 2001, Sep. 20, 2001, Sep. 20, 2001, Sep. 21, 2001, Sep. 21, 2001 and Sep. 21, 2001, respectively, the entire contents of which are hereby incorporated by reference.

What is claimed is:

1. A document data structure comprising:
at least one digital information file of a substance of a document;
a display information file for indicating a display state of said at least one digital information file on said document;
an operation program file read and executed by a computer for displaying said at least one information file according to the display state indicated by said display information file; and
an encapsulating part encapsulating said at least one digital information file, display information file and operation program file into a single document.

2. The document data structure claimed in claim 1, wherein said encapsulating part has a function of taking said at least one digital information file, display information file and operation program file into a single file.

3. The document data structure as claimed in claim 1, wherein said operation program file includes a starting file for responding to access to said document by the computer and causing said computer to read, execute and start said operation program file.

4. The document data structure as claimed in claim 3, wherein said document includes an icon file concerning icons to be selectably displayed according to the substantial data of said document, and, said starting program causing the computer to determine an operation of selecting from the icons as an access operation to said document.

5. The document data structure as claimed in claim 1, further comprising a library file holding said at least one digital information file with an index indicating where said at least one digital information file is held, said operation program file identifying said at least digital information file by means of said index.

6. The document data structure as claimed in claim 1, further comprising a library file holding said at least one digital information file having a unique header attached thereto, said operation program file identifying said at least one digital information file by mean of said header.

7. The document data structure as claimed in claim 1, wherein said display information file is described by a general data description language.

8. The document data structure as claimed in claim 7, wherein said data description language uses tags for identifying the structure of said at least one digital information file and the display state of said at least one digital information file on said document.

9. The document data structure as claimed in claim 8, wherein said operation program file is provided in such a manner as to correspond to a file form identified by said display information file described by using the tags.

10. The document data structure as claimed in claim 1, wherein said operation program file is provided in such a manner that a part thereof needed for processing said at least one digital information file is treated as a minimum unit.

11. The document data structure as claimed in claim 1, wherein said operation program file comprising a digital information display program for displaying said at least one digital information file, and a function operation program for executing a unique function without referring to said at least one digital information file.

12. The document data structure as claimed in claim 11, wherein said digital information display program has a function of displaying a file identification panel selectably displaying file identifying information for identifying said at least one digital information file, and a function of responding to selection of said file identifying information and displaying a corresponding digital information file.

13. The document data structure as claimed in claim 11, wherein said function operation program file has a function of displaying a function panel selectably displaying function identifying information for identifying a predetermined function, and a function of responding to selection of the function identifying information and causing the computer to executed the corresponding predetermined function.

14. The document data structure as claimed in claim 11, wherein said digital display program has a function of magnification and reduction of a display image based on said digital information file.

15. The document data structure as claimed in claim 11, wherein said digital information display program has a view-point changing function in case a display image based on said digital information file comprises a solid image.

16. The document data structure as claimed in claim 11, wherein said digital information display program has, in case a display image based on said digital information file comprises an animation image, a function of selectably displaying a still image thereof on said document and a function of, when said still image is selected, reproducing an animation image thereof.

17. The document data structure as claimed in claim 11, wherein said digital information display program has, in case said digital information file comprises voice information, has a function of a reproduction panel for inputting instructions of reproduction of said voice information and a function of, when the instructions of reproduction is input by means of said reproduction panel, reproducing said voice information.

18. The document data structure as claimed in claim 17, wherein said digital information program has a function of, when instructions of reproduction is input by means of said reduction panel, displaying text information corresponding to said voice information.

19. The document data structure as claimed in claim 1, wherein said operation program file of the local document operating in the computer comprises a function operation program having a function of performing communications via a communication network with another document having the same document data structure as that of said local document and operating in a different computer.

20. The document data structure as claimed in claim 19, holding a document identification code for identifying the own document,
wherein said function operation program of the local document operating in the computer has a function of, when the communications are performed with another document operating in a different computer, transmitting said document identification code for identifying said local document, and identifying the other part of the communications based on the document identification code for identifying the other document sent from the other computer.

21. The document data structure as claimed in claim 20, wherein said document identification code is held by said display information file.

22. The document data structure as claimed in claim 20, wherein said function operation program of the local document operating in the computer has a function of, when the communications are performed via the communication network with the other documents having the same data structure as that of said local document and operating in the other computers, sending the document identification code of said local document to all the other computers so as to send it to all the documents having the same data structure as that of said local document and operating in said all the other computes.

23. The document data structure as claimed in claim 19, wherein said function operation program has:
a function of transmitting a document identification code for identifying the local document, and a state ID for identifying a unique function; and
a function of executing a unique function identified by the state ID accompanying the other document sent from the other computer.

24. The document data structure as claimed in claim 20, having:
a function of holding a document identification code for identifying at least the other one document; and
a function of displaying a list of said at least the other one document identified by said document identification code.

25. The document data structure as claimed in claim 24, wherein said list of at least the other one document is displayed in such a manner that said at least the other one document can be recalled thereby.

26. The document data structure as claimed in claim 19, wherein said function operation program has:
a function of obtaining document sate information for identifying a sate of the local document;
a function of transmitting the thus-obtained state information to the other document having the same data structure as that of said local document and operating in the other computer; and
a function of reflecting received document state information on the local document.

27. The document data structure as claimed in claim 26, wherein said function operation program has a function of determining whether or not the received document state information is to be reflected on the local document.

28, The document data structure as claimed in claim 19, wherein said function operation program has a function of selecting all or some of at least the other one document having the same data structure as that of the local document and operating in the other computer, to which communications are performed via the communication network.

29. The document data structure as claimed in claim 20, wherein said function operation program has a communicatable document management program having:
a function of holding the document identification code of all the at least the other one document communicatable on the communication network; and
a function of determining whether or not a received document identification code coincides with the document identification code of the local document.

30. The document data structure as claimed in claim 29, wherein, when the computer operates a plurality of the local documents, said communicatable document management program starts from only one of the plurality of local documents.

31. The document data structure as claimed in claim 29, wherein, when the local document which started said communicatable document management program is closed, said function operation program transfers the function of said communicatable document management program to another one of the local documents operated by the computer.

32. The document data structure as claimed in claim 1, wherein said operation program file comprises a summary program for displaying a summary of said at least one digital information file.

33. The document data structure as claimed in claim 32, wherein the summary of the at least one digital information file includes a plurality of display elements, and said display information file comprises information for displaying the plurality of display elements in a switching manner in sequence.

34. The document data structure as claimed in claim 32, wherein said display information file comprises information for identifying a structure for the summary of said at least one digital information file and a display state thereof on the document.

35. The document data structure as claimed in claim 32, wherein said summary program has a function of producing a summary frame different from a display frame displaying said at least one digital information file, and displaying in said summary file a part of said at least one digital information file.

36. The document data structure as claimed in claim 33, wherein said plurality of display elements of the summary of the at least one digital information file is switched in display in sequence based on operation made by a user.

37. The document data structure as claimed in claim 33, wherein said plurality of display elements of the summary of the at least one digital information file is switched in display in sequence based on predetermined time intervals.

38. The document data structure as claimed in claim 35,, wherein said at least one digital information file is displayed in a manner such that a part thereof corresponding to a part displayed in the summary frame is emphasized.

39. The document data structure as claimed in claim 35, wherein said summary program has a function of voice synthesis, and, in case said at least one digital information file comprises text information, performs voice synthesis on the text information and reproduces thus-obtained voice information.

40. The document data structure as claimed in claim 35, wherein said summary program has a function of animation reproduction, and, in case said at least one digital information file comprises animation information, reproduces a part of said animation information.

41. The document data structure as claimed in claim 1, wherein said operation program file comprises a function operation program having a function of detecting a user's operation and recording it.

42. The document data structure as claimed in claim 41, wherein:
the function operation program included in the local document operates in the computer has:
a function of performing communications with another document having the same data structure as that of said local document; and
a function of recording communication information concerning the communications.

43. The document data structure as claimed in claim 41, further having a function of recording additional information to the record contents.

44. The document data structure as claimed in claim 43, wherein said additional information comprises at least one of a mark and a comment.

45. The document data structure as claimed in claim 41, having a function of recording time information concerning the recording in a manner such that the time information corresponds to record contents.

46. The document data structure as claimed in claim 42, wherein said function of recording the communication information records the communication information in such a manner that the recorded information can be distinguished for particular information senders.

47. The-document data structure as claimed in claim 41, wherein said function operation program has:
a function of displaying a history concerning the recording with respect to a time axis;
a function of receiving a user's operation for inputting a specific time on the time axis; and
a function of re-displaying the at least one digital information file in a state in which it was displayed at the specific time.

48. The document data structure as claimed in claim 41, wherein said function operation program has a function of reproducing a history concerning the recording together with the contents of the at least one digital information file in a state which were once displayed.

49. The document data structure as claimed in claim 48, wherein the reproduction display of the history concerning the recording and corresponding contents of the at least one digital information file is made for each record unit.

50. The document data structure as claimed in claim 41, wherein said function operation program has a function of receiving a user's operation for setting a record unit, and the recording is performed for each record unit thus set.

51. The document data structure as claimed in claim 1, having a function of, when the document encapsulated by said encapsulating part does not include the operation program file needed for displaying the at least one digital information file, obtaining it from another computer via a communication network.

52. The document data structure as claimed in claim 51, wherein the operation program file is provided so as to correspond to a plurality of types of platforms.

53. The document data structure as claimed in claim 51, wherein the operation program file to be obtained from said another computer via the communication network has a form adapted to the platform of the computer.

54. The document data structure as claimed in claim 1, wherein:
said at least one digital information file comprises descriptions in a plurality of languages having the same contents; and
said operation program file comprises a function operation program which accept selection of language to be displayed.

55. The document data structure as claimed in claim 1, wherein:
said at least one digital information file comprises a meaning data file holding a description for a term included in the document; and
said operation program file comprises a function operation program for responding to selection of a term of the document displayed, extracting the correspond description from said meaning data file, and displaying it.

56. A computer readable recording medium storing the document data structure claimed in claim 1.

57. A computer readable recording medium storing the document data structure claimed in claim 2.

58. A computer readable recording medium storing the document data structure claimed in claim 3.

59. A computer readable recording medium storing the document data structure claimed in claim 4.

60. A computer readable recording medium storing the document data structure claimed in claim 5.

61. A computer readable recording medium storing the document data structure claimed in claim 6.

62. A computer readable recording medium storing the document data structure claimed in claim 7.

63. A computer readable recording medium storing the document data structure claimed in claim 8.

64. A computer readable recording medium storing the document data structure claimed in claim 9.

65. A computer readable recording medium storing the document data structure claimed in claim 10.

66. A computer readable recording medium storing the document data structure claimed in claim 11.

67. A computer readable recording medium storing the document data structure claimed in claim 12.

68. A computer readable recording medium storing the document data structure claimed in claim 13.

69. A computer readable recording medium storing the document data structure claimed in claim 14.

70. A computer readable recording medium storing the document data structure claimed in claim 15.

71. A computer readable recording medium storing the document data structure claimed in claim 16.

72. A computer readable recording medium storing the document data structure claimed in claim 17.

73. A computer readable recording medium storing the document data structure claimed in claim 18.

74. A computer readable recording medium storing the document data structure claimed in claim 19.

75. A computer readable recording medium storing the document data structure claimed in claim 20.

76. A computer readable recording medium storing the document data structure claimed in claim 21.

77. A computer readable recording medium storing the document data structure claimed in claim 22.

78. A computer readable recording medium storing the document data structure claimed in claim 23.

79. A computer readable recording medium storing the document data structure claimed in claim 24.

80. A computer readable recording medium storing the document data structure claimed in claim 25.

81. A computer readable recording medium storing the document data structure claimed in claim 26.

82. A computer readable recording medium storing the document data structure claimed in claim 27.

83. A computer readable recording medium storing the document data structure claimed in claim 28.

84. A computer readable recording medium storing the document data structure claimed in claim 29.

85. A computer readable recording medium storing the document data structure claimed in claim 30.

86. A computer readable recording medium storing the document data structure claimed in claim 31.

87. A computer readable recording medium storing the document data structure claimed in claim 32.

88. A computer readable recording medium storing the document data structure claimed in claim 33.

89. A computer readable recording medium storing the document data structure claimed in claim 34.

90. A computer readable recording medium storing the document data structure claimed in claim 35.

91. A computer readable recording medium storing the document data structure claimed in claim 36.

92. A computer readable recording medium storing the document data structure claimed in claim 37.

93. A computer readable recording medium storing the document data structure claimed in claim 38.

94. A computer readable recording medium storing the document data structure claimed in claim 39.

95. A computer readable recording medium storing the document data structure claimed in claim 40.

96. A computer readable recording medium storing the document data structure claimed in claim 41.

97. A computer readable recording medium storing the document data structure claimed in claim 42.

98. A computer readable recording medium storing the document data structure claimed in claim 43.

99. A computer readable recording medium storing the document data structure claimed in claim 44.

100. A computer readable recording medium storing the document data structure claimed in claim 45.

101. A computer readable recording medium storing the document data structure claimed in claim 46.

102. A computer readable recording medium storing the document data structure claimed in claim 47.

103. A computer readable recording medium storing the document data structure claimed in claim 48.

104. A computer readable recording medium storing the document data structure claimed in claim 49.

105. A computer readable recording medium storing the document data structure claimed in claim 50.

106. A computer readable recording medium storing the document data structure claimed in claim 51.

107. A computer readable recording medium storing the document data structure claimed in claim 52.

108. A computer readable recording medium storing the document data structure claimed in claim 53.

109. A computer readable recording medium storing the document data structure claimed in claim 54.

110. A computer readable recording medium storing the document data structure claimed in claim 55.

111. An information processing apparatus comprising a computer and the document data structure claimed in claim 1 which can be viewed by means of said computer.

112. An information processing apparatus comprising a computer and the document data structure claimed in claim 19 which can be viewed by means of said computer.

113. An information processing apparatus comprising a computer and the document data structure claimed in claim 32 which can be viewed by means of said computer.

114. An information processing apparatus comprising a computer and the document data structure claimed in claim 41 which can be viewed by means of said computer.

115. An information processing apparatus comprising a computer and the document data structure claimed in claim 51 which can be viewed by means of said computer.

116. An information processing apparatus comprising a computer and the document data structure claimed in claim 54 which can be viewed by means of said computer.

117. An information processing apparatus comprising a computer and the document data structure claimed in claim 55 which can be viewed by means of said computer.

118. An information processing system comprising:
the information processing apparatus claimed in claim 115; and
another computer which said information processing apparatus can access, and can send thereto the operation program file needed for displaying the at least one digital information file.

119. The information processing system as claimed in claim 118, wherein:
when starting the document, said information processing apparatus sends an identification of said document to said another component; and
said another computer sends the operation program file needed for displaying the at least one digital information file only when the identification code is included in a predetermined list managed by itself.

120. The information processing system as claimed in claim 118, wherein:
when starting the document, said information processing apparatus sends an identification of said document to said another component; and
said another computer determines a user who sent the identification code, and sends a digital information file including information concerning the thus-determined user to the information processing apparatus and to all the other information processing apparatuses present, if any, on the communication network.

121. The information processing system as claimed in claim 118, wherein:
when starting the document, said information processing apparatus sends an identification of said document to said another component; and
said another computer determines the version of the document based on the thus-sent identification code, and, when the thus-determined version is older than that of the same document said another computer has, sends information of the new version to said information processing apparatus.

122. The information processing system as claimed in claim 121, wherein said information of the new version comprises the digital information file of said version.

123. The information processing system as claimed in claim 121, wherein said information of the new version comprises the operation program file of said version.

124. A document processing method for exchanging information between a user apparatus and a service apparatus via a communication network, comprising the steps of:
a) the service apparatus receiving a document from the user apparatus;
b) the service apparatus converting the document into an encapsulated document; and
c) the service apparatus returning the encapsulated document to the user apparatus,
wherein said encapsulated document comprises:
at least one digital information file of a substance of the document;
a display information file for indicating a display state of said at least one digital information file on said document;
an operation program file read and executed by a computer for displaying aid at least one information file according to the display state indicated by said display information file; and
an encapsulating part encapsulating said at least one digital information file, display information file and operation program file into a single document.

125. The document processing method as claimed in claim 124, wherein:
said step c) comprises the steps of:
c-1) the service apparatus transmitting a temporary one of the encapsulated document;
c-2) the service apparatus receiving an acceptance from the user apparatus on the temporary one; and
c-3) the service apparatus transmitting a regular one of the encapsulated document after said step c-2).

126. The document processing method as claimed in 124, wherein said step b) comprises a step of translating the document by means of an automatic translation function, and producing the encapsulated document having the thus-obtained translation attached thereto.

127. The document processing method as claimed in claim 124, wherein said step b) comprises the step of producing the encapsulated document having attached thereto:
a meaning data file holding respective descriptions of terms included in the document; and
a function operation program for responding to a selection of a term from the document currently displayed, extracting the corresponding description from said meaning data file, and displaying the extracted description.
